(19) United States
(12) Patent Application Publication
(10) Pub. No.: US 2026/0304252 A1
(43) Pub. Date: Oct. 1, 2026

(54) SERVING-CELL-TO-CANDIDATE-CELL TIMING ADVANCE GROUP MAPPING

(71) Applicant: QUALCOMM Incorporated, San Diego, CA (US)

(72) Inventors: Toru UCHINO, Zushi-shi (JP); Shankar KRISHNAN, Poway, CA (US); Doohyun SUNG, Basking Ridge, NJ (US); Punyaslok PURKAYASTHA, San Diego, CA (US); Prasada Veera Reddy KADIRI, San Diego, CA (US); Jelena DAMNJANOVIC, Del Mar, CA (US)

(21) Appl. No.: 19/546,116

(22) Filed: Feb. 20, 2026

Related U.S. Application Data
(60) Provisional application No. 63/777,181, filed on Mar. 25, 2025.

(51) Int. Cl. H04W 36/00

(52) U.S. Cl. CPC H04W 36/0077; H04W 36/00725

(57) ABSTRACT

Various aspects of the present disclosure generally relate to wireless communication. In some aspects, a user equipment (UE) may receive, from a serving cell belonging to a first timing advance group (TAG), a control message that configures a candidate cell, information identifying a second TAG to which the candidate cell belongs, and mapping information that identifies a mapping between the first TAG and the second TAG. The UE may perform a handover between the serving cell and the candidate cell based at least in part on the mapping information. Numerous other aspects are described.

### CROSS-REFERENCE TO RELATED APPLICATION

This Patent Application claims priority to U.S. Provisional Patent Application No. 63/777,181, filed on Mar. 25, 2025, entitled “SERVING-CELL-TO-CANDIDATE-CELL TIMING ADVANCE GROUP MAPPING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with serving-cell-to-candidate-cell timing advance group mapping.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories and one or more processors coupled to the one or more memories. The one or more processors may be individually or collectively configured to receive, from a serving cell belonging to a first timing advance group (TAG), a control message that configures a candidate cell, information identifying a second TAG to which the candidate cell belongs, and mapping information that identifies a mapping between the first TAG and the second TAG. The one or more processors may be individually or collectively configured to perform a handover between the serving cell and the candidate cell based at least in part on the mapping information.

Some aspects described herein relate to a network node for wireless communication. The network node may include one or more memories and one or more processors coupled to the one or more memories. The one or more processors may be individually or collectively configured to transmit, to a UE via a serving cell of the network node belonging to a first TAG, a control message that configures a candidate cell, information identifying a second TAG to which the candidate cell belongs, and mapping information that identifies a mapping between the first TAG and the second TAG.

Some aspects described herein relate to a method of wireless communication performed by a UE. The method may include receiving, from a serving cell belonging to a first TAG, a control message that configures a candidate cell, information identifying a second TAG to which the candidate cell belongs, and mapping information that identifies a mapping between the first TAG and the second TAG. The method may include performing a handover between the serving cell and the candidate cell based at least in part on the mapping information.

Some aspects described herein relate to a method of wireless communication performed by a network node. The method may include transmitting, to a UE via a serving cell of the network node belonging to a first TAG, a control message that configures a candidate cell, information identifying a second TAG to which the candidate cell belongs, and mapping information that identifies a mapping between the first TAG and the second TAG.

Some aspects described herein relate to a non-transitory computer-readable medium that stores a set of instructions for wireless communication by a UE. The set of instructions, when executed by one or more processors of the UE, may cause the UE to receive, from a serving cell belonging to a first TAG, a control message that configures a candidate cell, information identifying a second TAG to which the candidate cell belongs, and mapping information that identifies a mapping between the first TAG and the second TAG. The set of instructions, when executed by one or more processors of the UE, may cause the UE to perform a handover between the serving cell and the candidate cell based at least in part on the mapping information.

Some aspects described herein relate to a non-transitory computer-readable medium that stores a set of instructions for wireless communication by a network node. The set of instructions, when executed by one or more processors of the network node, may cause the network node to transmit, to a UE via a serving cell of the network node belonging to a first TAG, a control message that configures a candidate cell, information identifying a second TAG to which the candidate cell belongs, and mapping information that identifies a mapping between the first TAG and the second TAG.

Some aspects described herein relate to an apparatus for wireless communication. The apparatus may include means for receiving, from a serving cell belonging to a first TAG, a control message that configures a candidate cell, information identifying a second TAG to which the candidate cell belongs, and mapping information that identifies a mapping between the first TAG and the second TAG. The apparatus may include means for performing a handover between the serving cell and the candidate cell based at least in part on the mapping information.

Some aspects described herein relate to an apparatus for wireless communication. The apparatus may include means for transmitting, to a UE via a serving cell of the network node belonging to a first TAG, a control message that configures a candidate cell, information identifying a second TAG to which the candidate cell belongs, and mapping information that identifies a mapping between the first TAG and the second TAG.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a Layer 1/Layer 2 triggered mobility (LTM) procedure.

FIG. 3 is a diagram illustrating example for common timing advance group (TAG) management in conditional LTM.

FIG. 4 is a diagram illustrating example of common TAG management in conditional LTM for a random access channel-less handover.

FIGS. 5A and 5B are diagrams illustrating examples of TAG management for uplink carrier aggregation.

FIGS. 6A and 6B are diagrams illustrating examples of TAG mapping to enable skipping of an uplink synchronization procedure.

FIG. 7 is a diagram illustrating an example associated with signaling that enables serving-cell-to-candidate-cell TAG mapping.

FIG. 8 is a diagram illustrating example associated with common TAG and TAG management after a handover.

FIG. 9 is a diagram illustrating an example process performed, for example, at a user equipment or an apparatus of a user equipment.

FIG. 10 is a diagram illustrating an example process performed, for example, at a network node or an apparatus of a network node.

FIG. 11 is a diagram of an example apparatus for wireless communication.

FIG. 12 is a diagram of an example apparatus for wireless communication.

### DETAILED DESCRIPTION

In wireless communication systems, mobility management may enable connectivity for a user equipment (UE) as the UE moves across different geographic locations and radio conditions. Mobility events, such as handovers, may be procedures that transfer the connection of a UE from one cell (e.g., serving cell) to another (e.g., a target or candidate cell). Handover procedures (including those triggered based on Layer 1/Layer 2 (L1/L2) conditions) can introduce latency and service interruption, which may result in a negative user experience and reduce network efficiency. For example, to handover from a serving cell to a candidate cell, the UE may perform uplink synchronization (such as a pre-synchronization procedure, or a random access procedure during handover, among other examples) with one or more candidate cells to synchronize timing parameters (such as a time alignment (TA) value, which may be an example of a timing advance value).

In some examples, the UE may reduce a number of uplink synchronization procedures based on the network configuring multiple candidate cells in one or more common timing advance groups (C-TAGs). For example, a C-TAG may include multiple candidate cells that have the same or similar TA values. Therefore, the UE may perform an uplink synchronization procedure per C-TAG to determine common timing parameters (such as a TA value or a TA timer) that apply to multiple candidate cells, reducing a total number of uplink synchronization procedures. However, if the UE performs uplink synchronization at the C-TAG level, the UE may still have to perform at least one uplink synchronization procedure to enable handover, which may result in latency increases for handover. Furthermore, in addition to C-TAGs (for candidate cells), the UE may be configured with timing advance groups (TAGs) that support uplink carrier aggregation (CA) (e.g., TAGs for serving cells). Such a coexistence of TAGs for serving cells and C-TAGs for candidate cells may involve UE capability to support multiple TAGs and TAG types, as well as the flexible grouping of serving cells and candidate cells based on shared propagation characteristics. Moreover, if the UE performs uplink synchronization for one or more candidate cells, there may be a potential for interruption on the serving cell, which can lead to throughput degradation. Such degradation may be further exacerbated as the number of candidate cells (or C-TAGs) increases.

Various aspects relate generally to enhancing wireless communication by improving handover execution and TA management for a UE and a network. Some aspects more specifically relate to a UE receiving a control message, from a serving cell that belongs to a TAG, that configures a candidate cell, provides information identifying a C-TAG to which the candidate cell belongs, and includes mapping information that identifies a mapping between the TAG of the serving cell and the C-TAG. Accordingly, the UE may perform a handover between the serving cell and the candidate cell based on the mapping information. In some aspects, the handover can be a random access channel (RACH)-less handover that skips an uplink synchronization procedure based on leveraging the mapping information indicating that a TA value of the C-TAG is valid when the handover is triggered. In some examples, the mapping information may indicate that the C-TAG shares a TA timer and a TA value that is configured for the TAG of the serving cell. In some other examples, the TAG of the serving cell may have a first TA timer and a first TA value and the C-TAG may have a second TA timer and a second TA value, and the mapping information may indicate that updates to the first TA timer and the first TA value apply to the second TA timer and the second TA value (or vice versa).

Particular aspects of the subject matter described in this disclosure can be implemented to realize one or more of the following potential technical advantages. By employing mapping information that correlates the TA values and TA timers of serving and candidate cells, the UE can use a valid TA value from a serving cell TAG for a candidate cell, enabling RACH-less handover and allowing the UE to skip uplink synchronization with the candidate cell. Accordingly, such techniques may reduce the signaling overhead and latency associated with traditional handover procedures, thereby conserving network resources. Furthermore, by the UE supporting multiple TAGs for both serving cells and candidate cells, the network may optimize cell grouping based on shared propagation characteristics between TAGs for serving cells and C-TAGs. Such optimization may reduce handover complexity and enhance communication efficiency, leading to better utilization of network resources. Moreover, by ensuring the validity of TA values during the handover process, the integrity of a communication link between the UE and the network may be maintained, which may increase reliability of wireless networks. This maintenance of link integrity can conserve network and processing resources by avoiding unnecessary handover retries and signal correction procedures. In some aspects, detailed capability reporting by the UE, including supported frequency bands for TAGs associated with candidate cells, may enable efficient TA management across different network configurations. This granular insight into the operational capabilities of the UE may enable the network to conserve resources by optimizing frequency band allocation and reducing the need for frequent TA adjustments. In this way, the described techniques for managing TA values and handover execution may conserve one or more of processing resources, memory resources, or network resources, which may contribute to smoother and more resource-efficient mobility management in wireless communication systems.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

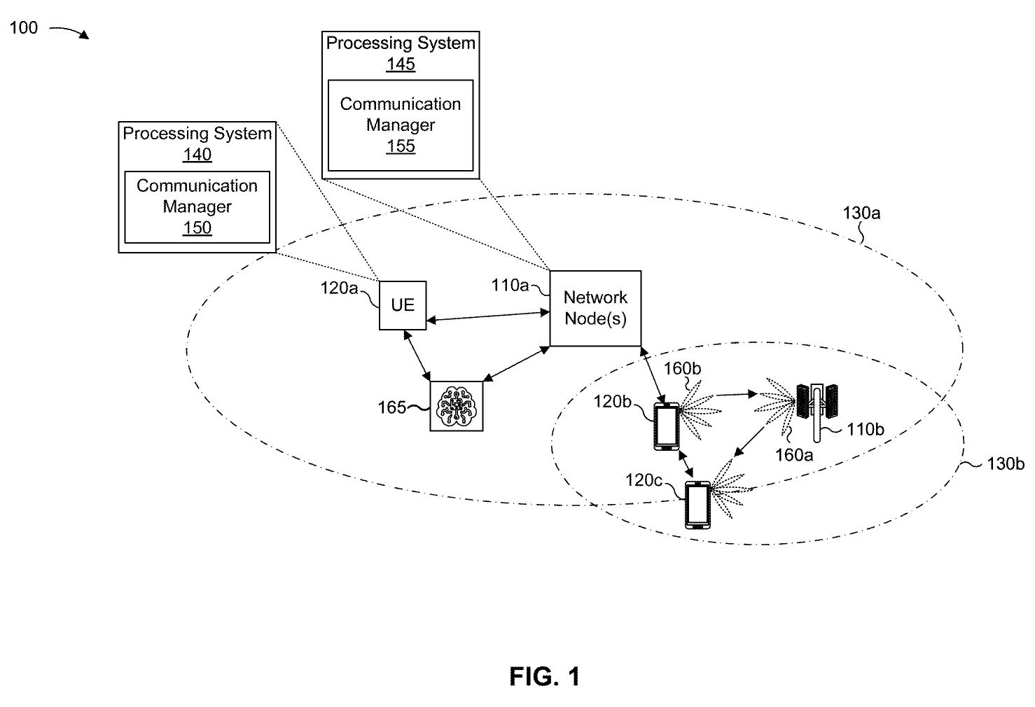

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110aor the UE 120amay perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120amay transmit the processed downlink or uplink signals, respectively, via one or more antennas.

The network node 110a or the UE 120a may receive uplink signals or downlink signals, respectively, via one or more antennas. The network node 110a or the UE 120a(for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110aor the UE 120a(for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a serving cell belonging to a first TAG, a control message that configures a candidate cell, information identifying a second TAG to which the candidate cell belongs, and mapping information that identifies a mapping between the first TAG and the second TAG; and perform a handover between the serving cell and the candidate cell based at least in part on the mapping information. Additionally, or alternatively, the communication manager 150 may perform one or more other operations described herein.

In some aspects, the network node 110 may include a communication manager 155. As described in more detail elsewhere herein, the communication manager 155 may transmit, to a UE via a serving cell of the network node belonging to a first TAG, a control message that configures a candidate cell, information identifying a second TAG to which the candidate cell belongs, and mapping information that identifies a mapping between the first TAG and the second TAG. Additionally, or alternatively, the communication manager 155 may perform one or more other operations described herein.

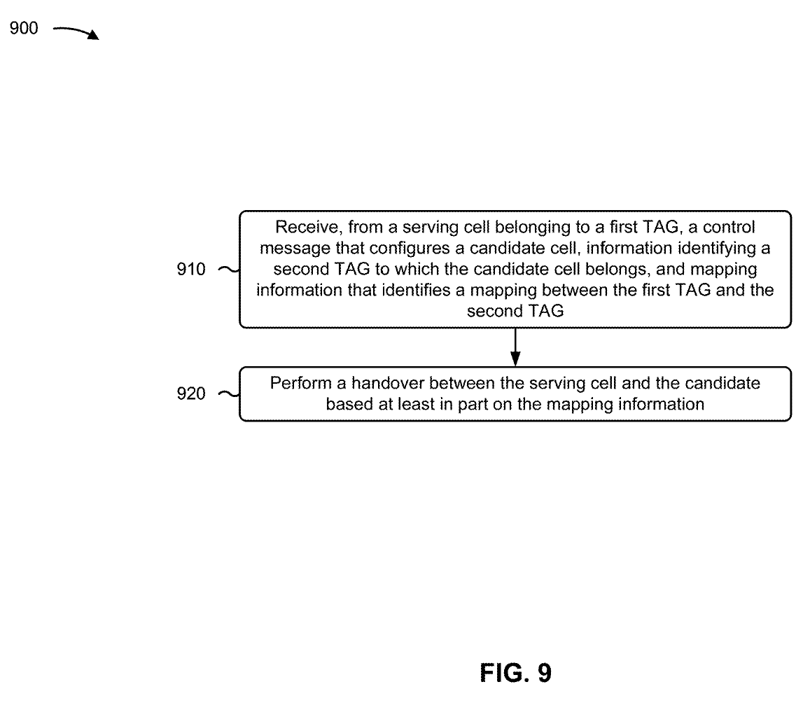

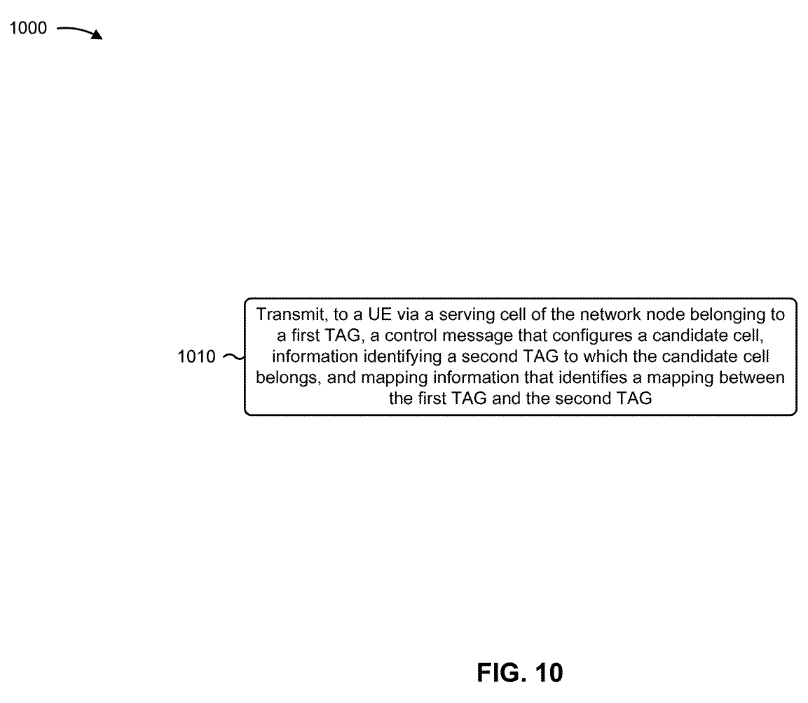

The network node 110, the processing system 145 of the network node 110, the UE 120, the processing system 140 of the UE 120, or any other component(s) of FIG. 1 may implement one or more techniques or perform one or more operations associated with serving-cell-to-candidate-cell TAG mapping, as described in more detail elsewhere herein. For example, the processing system 145 of the network node 110, or the processing system 140 of the UE 120 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

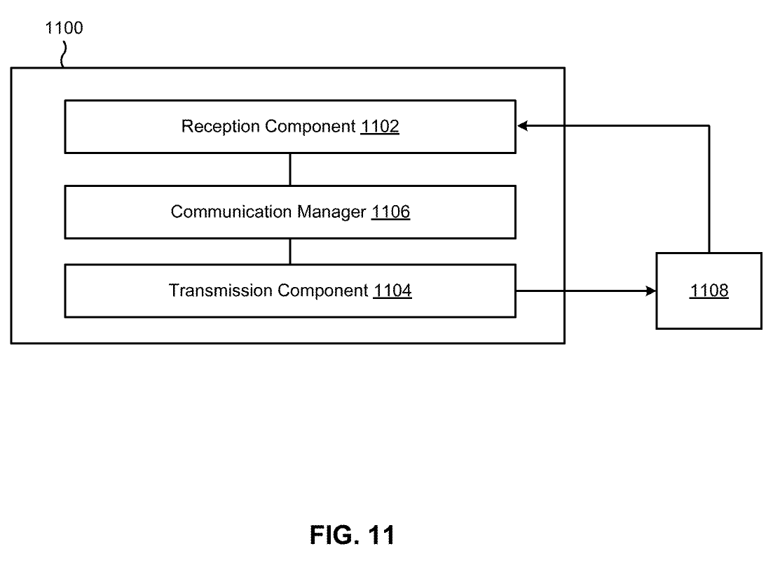

In some aspects, the UE 120 includes means for receiving, from a serving cell belonging to a first TAG, a control message that configures a candidate cell, information identifying a second TAG to which the candidate cell belongs, and mapping information that identifies a mapping between the first TAG and the second TAG; or means for performing a handover between the serving cell and the candidate cell based at least in part on the mapping information. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

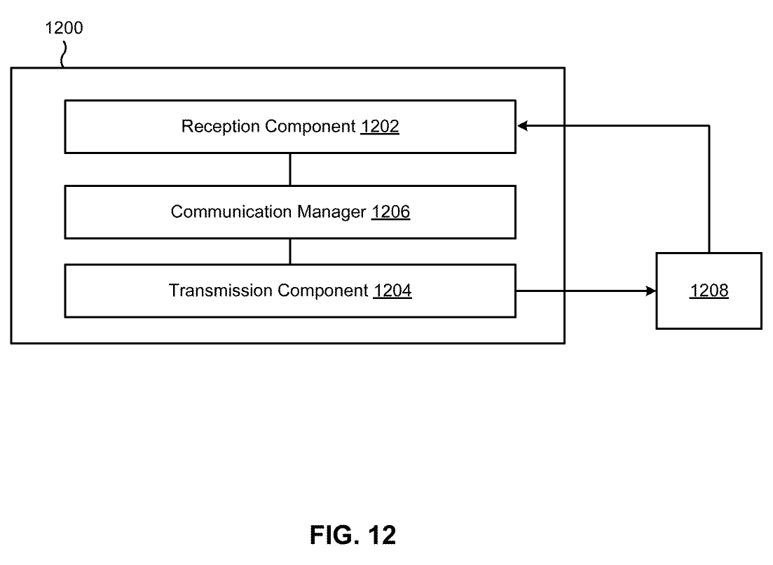

In some aspects, the network node 110 includes means for transmitting, to a UE via a serving cell of the network node belonging to a first TAG, a control message that configures a candidate cell, information identifying a second TAG to which the candidate cell belongs, and mapping information that identifies a mapping between the first TAG and the second TAG. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

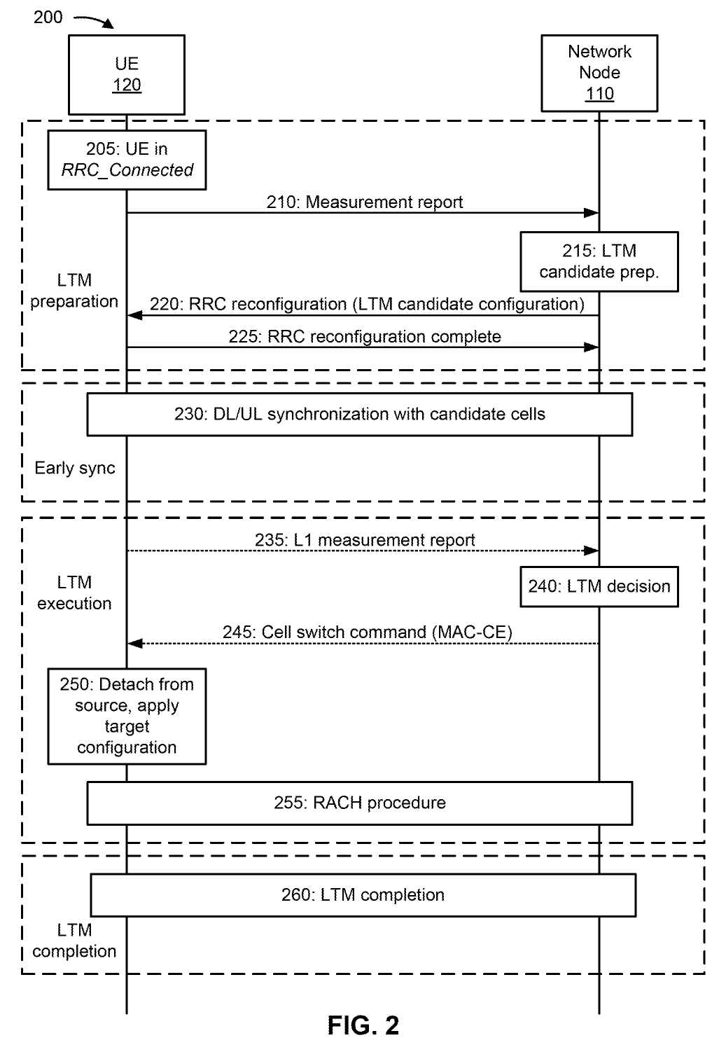

FIG. 2 is a diagram illustrating an example 200 of a Layer 1/Layer 2 (L1/L2) triggered mobility (LTM) procedure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using a layer 3 (L3) handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages or other L3 signaling and operations used to perform the handover procedures. Accordingly, in some examples, a UE 120 may be configured to perform a lower-layer (e.g., L1 or L2) handover procedure, sometimes referred to an LTM procedure, such as the example 200 LTM procedure shown in FIG. 2. As shown in FIG. 2, the LTM procedure may include four phases: an LTM preparation phase, an early synchronization phase (shown as “early sync” in FIG. 2), an LTM execution phase, or an LTM completion phase.

During the LTM preparation phase, and as shown by reference number 205, the UE 120 may be in an RRC connected state (sometimes referred to as RRC_Connected) with a source cell. As shown by reference number 210, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, or CQI) or similar measurements associated with the source cell or one or more neighboring cells. In some examples, based at least in part on the measurement report or other information, the network node 110 may decide to use LTM, and thus, as shown by reference number 215, the network node 110 may initiate LTM candidate preparation.

As shown by reference number 220, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE or cells for which the UE 120 may later be triggered to perform an LTM procedure. As shown by reference number 225, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 230, the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with reference number 225). In some aspects, performing the early synchronization with the one or more candidate cells may reduce latency associated with performing a RACH procedure later in the LTM procedure, which is described in more detail below in connection with reference number 255.

During the LTM execution phase, and as shown by reference number 235, the UE 120 may perform L1 measurements on the configured LTM candidate target cells, and thus may transmit, to the network node 110, lower-layer (e.g., L1) measurement reports. As shown by reference number 240, based at least in part on the lower-layer measurement reports, the network node 110 may decide to execute an LTM cell switch to a target cell. Accordingly, as shown by reference number 245, the network node 110 may transmit, and the UE 120 may receive, a MAC control element (MAC-CE) or similar message triggering an LTM cell switch (the MAC-CE or similar message is sometimes referred to herein as a cell switch command). The cell switch command may include an indication of a candidate configuration index associated with the target cell. As shown by reference number 250, based at least in part on receiving the cell switch command, the UE 120 may switch to the configuration of the LTM candidate target cell (e.g., the UE 120 may detach from the source cell and apply the target cell configuration). Moreover, as shown by reference number 255, the UE 120 may perform a RACH procedure towards the target cell, such as when a timing advance associated with the target cell is not available (e.g., in examples in which the UE 120 did not perform the early synchronization as described above in connection with reference number 230).

During the LTM completion phase, and as shown by reference number 260, the UE 120 may indicate successful completion of the LTM cell switch towards the target cell. In this way, cell switch to a target cell may be performed using less overhead than for an L3 handover procedure or a cell switch to a target cell may be associated with reduced latency as compared to L3 handover procedure.

As indicated above, FIG. 2 is provided as an example. Other examples may differ from what is described with respect to FIG. 2.

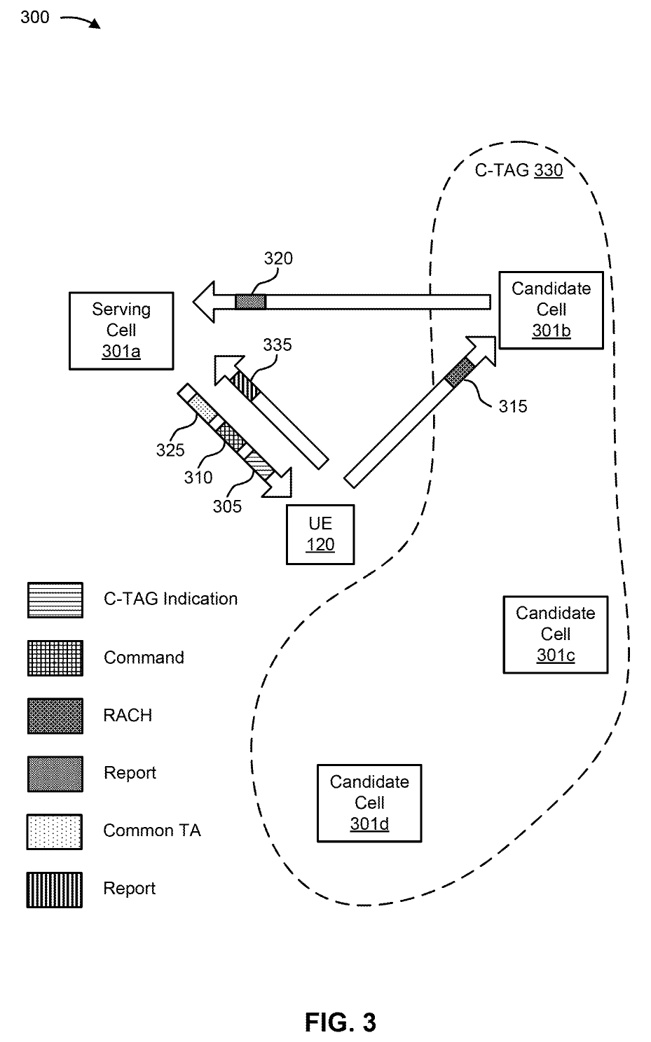

FIG. 3 is a diagram illustrating example 300 for C-TAG management in conditional LTM (C-LTM). In some instances, example 300 may implement or be implemented by one or more aspects of FIGS. 1 and 2. For instance, the example 300 may include a serving cell 301a, a candidate cell 301b, a candidate cell 301c, a candidate cell 301d, and a UE 120, which may be examples of corresponding devices as described with reference to FIG. 1. In the present disclosure, the terms “cell 301,” “serving cell 301,” “candidate cell 301,” and like terms, may refer to a set of hardware resources or time/frequency/spatial resources that supports communications between the network and UEs 120. That is, each serving cell 301 may be associated with, or supported by, one or more network nodes 110. Similarly, a network node 110 may be associated with, or support, one or more cells.

The UE 120 may be configured with a TA group of one or more candidate cells, which may be referred to as a C-TAG 330. For example, the UE 120 may receive, from the serving cell 301a, a control message including a C-TAG indication 305. The C-TAG indication 305 may indicate that the candidate cell 301b (e.g., a first candidate cell), the candidate cell 301c (e.g., a second candidate cell), and the candidate cell 301d (e.g., a third candidate cell) are included in a C-TAG 330. While the C-TAG 330 includes three candidate cells 301 in the example of FIG. 3, the C-TAG 330 may include fewer or greater than three candidate cells 301. That is, the C-TAG 330 may include multiple or a plurality of candidate/neighboring cells 301.

The control message including the C-TAG indication 305 may include a C-TAG identifier (ID), one or more candidate cell 301 IDs (e.g., IDs of the candidate cell 301b, the candidate cell 301c, and the candidate cell 301d included in the C-TAG 330), one or more RSRP change thresholds (e.g., one or more L1 RSRP change thresholds, one or more L3 RSRP change thresholds, or both), and one or more validation timers.

For example, the control message may indicate a single RSRP change threshold (e.g., a single L1 RSRP change threshold, a single L3 RSRP change threshold, or both) applicable to each candidate cell in the C-TAG 330. Additionally, or alternatively, the control message may indicate multiple RSRP change thresholds applicable to individual candidate cells in the C-TAG 330. For example, the control message may indicate a first RSRP change threshold associated with the candidate cell 301b, a second RSRP change threshold associated with the candidate cell 301c, and a third RSRP change threshold associated with the candidate cell 301d. In some examples, the control message may indicate multiple RSRP change thresholds, where an RSRP change threshold of the multiple RSRP change thresholds is applicable to multiple candidate cells. As an example, the control message may indicate a first RSRP change threshold associated with the candidate cell 301b and the candidate cell 301c, and a second RSRP change threshold associated with the candidate cell 301d. That is, the control message may indicate RSRP change thresholds for individual candidate cells, RSRP change thresholds shared among two or more candidate cells, or both.

Similarly, the control message may indicate validation timers associated with individual candidate cells 301, validation timers shared between two or more candidate cells 301, or both. For example, the control message may indicate a validation timer applicable to each candidate cell 301 in the C-TAG 330. Additionally, or alternatively, the control message may indicate multiple validation timers applicable to individual candidate cells 301 in the C-TAG 330.

The UE 120 may perform common TA management and validation for the C-TAG 330. By performing common TA management and validation, the UE 120 may reduce a quantity of PDCCH-ordered RACH procedures (e.g., compared to performing PDCCH-ordered RACH procedures for individual candidate cells 301), reduce an amount of TA validation, or both. For example, the C-TAG indication 305 may indicate a common TA timer (e.g., a common validation timer), a common RSRP change threshold, or both for the C-TAG 330.

In some examples, the control message including the C-TAG indication 305 may be an RRC message (e.g., an RRC-based semi-static configuration or an RRC- and MAC-CE-based dynamic configuration). In such examples, the serving cell 301a may update the C-TAG 330 via an RRC or via MAC-CE. Alternatively, the control message including the C-TAG indication 305 may be a MAC-CE message (e.g., a MAC-CE-based dynamic configuration). In such examples, the serving cell 301a may update the C-TAG 330 via MAC-CE.

The UE 120 may receive a command 310 indicating to perform a RACH procedure with a candidate cell 301 (e.g., command 310 to transmit a RACH 315 to a candidate cell 301 of the C-TAG 330). The command 310 may be a PDCCH-ordered RACH command. That is, the serving cell 301a may transmit a downlink control message (e.g., a PDCCH message) including a command to initiate a RACH procedure with a candidate cell 301 of the C-TAG 330. Based on the command 310, the UE 120 may transmit a RACH 315 message to the candidate cell 301b (e.g., the candidate cell 301 indicated in the command 310). For example, the UE 120 may perform a single PDCCH-ordered RACH with a single candidate cell 301 rather than multiple PDCCH-ordered RACHs to multiple candidate cells 301. Accordingly, the UE 120 may reduce signaling overhead with the serving cell 301a (e.g., reduce a quantity of PDCCH-ordered RACH commands) and the candidate cells 301, including the candidate cell 301b, the candidate cell 301c, and the candidate cell 301d (e.g., reduce a quantity of RACHs).

The candidate cell 301b may transmit a report 320 to the serving cell 301a based on the RACH 315. For example, the candidate cell 301bmay transmit a report 320 including TA information to the serving cell 301a, such as via a backhaul link. The serving cell 301amay, based on the report 320, transmit an indication of a common TA 325 to the UE 120. That is, the serving cell 301amay transmit TA signaling to the UE 120. The UE 120 may apply the common TA 325 to candidate cells 301 in the C-TAG 330. For example, because the candidate cell 301bassociated with the common TA 325 is included in the C-TAG 330, the UE 120 may apply the common TA 325 to the candidate cell 301c and the candidate cell 301d. Put another way, the UE 120 may use the common TA 325 to communicate with the candidate cell 301c, the candidate cell 301d, or both, even without transmitting separate RACHs 315 to the candidate cell 301c or the candidate cell 301d.

In some examples, the serving cell 301amay indicate the common TA 325 via group-level signaling (e.g., via a MAC-CE). That is, based on a signaling type (e.g., group-level signaling) used to indicate the common TA 325, the UE 120 may determine that the common TA 325 is applicable to the C-TAG 330. Put another way, the UE 120 may assume to use the signaled common TA 325 for all candidate cells 301 within the C-TAG 330, including candidate cells 301 for which the UE 120 has not performed a PDCCH-ordered RACH procedure.

In the present disclosure, the term “common TA” may be used to refer to a TA value that is common across the C-TAG 330 as a whole (e.g., associated with all candidate cells 301 of the C-TAG 330), whereas the term “individual TA” may be used to refer to TA values that are specific to individual cells 301. Thus, in some cases, in order to communicate with the candidate cell 301b, the UE 120 may be configured to use the common TA 325 for the C-TAG 330, the individual TA for the candidate cell 301b, or both. The individual TAs may be different from the common TA 325. For example, the common TA 325 may be an average or a weighted average of the individual TAs of the candidate cells 301 in the C-TAG 330.

In some examples, the UE 120 may determine a common TA 325 absent group-level signaling. For example, when group-level signaling is not provided or when cell-level signaling is provided, the UE 120 may determine an individual TA for a candidate cell 301 whose individual TA is unknown or invalid (e.g., the UE 120 performed PDCCH-ordered RACH a long time ago such that the individual TA is invalid, the UE 120 has not performed PDCCH-ordered RACH for the candidate cell, etc.). That is, the UE 120 may receive the indication of an individual TA via cell-level signaling, where the cell-level signaling does not indicate that the individual TA is applicable to the C-TAG 330 (e.g., is not a common TA 325). In such examples, the UE 120 may determine the common TA 325 for the C-TAG 330 based on available or valid individual TAs for other candidate cells within the C-TAG 330. For example, the UE 120 may obtain one or more individual TAs associated with one or more candidate cells in the C-TAG 330. The UE 120 may determine, from the one or more individual TAs, a minimum, a maximum, an average, or a weighted average to use as a common TA 325 for a candidate cell 301 within the C-TAG 330. In such examples, the UE 120 may calculate the common TA 325 based on an RRC configuration or information stored in the memory of the UE 115.

In some examples, the UE 120 may measure an individual TA of at least one candidate cell 301 and use the measured individual TA as the common TA 325 for the C-TAG 330. For example, the UE 120 may exchange reference signals with the candidate cell 301c and measure an individual TA. The UE 120 may use the measured individual TA as the common TA 325 based on the candidate cell 301c being included within the C-TAG 330. The UE 115 may determine the common TA 325 based on available or valid individual TAs, or based on measurements according to a configuration from the serving cell 301a. That is, the serving cell 301amay indicate, via the control message including the C-TAG indication 305 or via a different control message, that the UE 120 is to determine a common TA 325 based on valid individual TAs obtained by the UE 120 (e.g., prior to receipt of the indication), or based on measuring an individual TA of a candidate cell in the C-TAG 330 (e.g., after receipt of the indication).

The UE 120 may reset a validation timer based on receiving the indication of the common TA 325 (e.g., via group-level signaling or cell-level signaling). For example, when the UE 120 receives the indication of the common TA 325, the UE 120 may reset the validation timer associated with the C-TAG 330. In some cases, the UE 120 may reset the validation timer for the common TA 325 in cases where an individual TA for an individual candidate cell 301 within the C-TAG 330 is updated (e.g., update the validation timer for the common TA 325 when an individual TA for any of candidate cells 301b, 301c, 301d is updated via cell-level signaling).

The UE 120 may use the RSRP change thresholds, the validation timers, or both, to validate the common TA 325 for the C-TAG 330 or individual TAs of the individual candidate cells 301. For example, the UE 120 may determine whether an individual TA is valid for a candidate cell 301, or whether the common TA is valid for the C-TAG 330, based on an RSRP change threshold, a validation timer, or both, associated with the candidate cell 301 or C-TAG 330. The individual TA or common TA 325 may be valid according to an RSRP change threshold if a current RSRP value of a downlink pathloss reference signal is within (e.g., has not increased or decreased by more than) the RSRP change threshold from a stored RSRP value and if the current RSRP value and the stored RSRP value are valid.

For instance, the UE 120 may perform measurements (e.g., RSRP measurements) on reference signals received from the candidate cell 301b to determine whether the RSRP of the candidate cell 301b changes by more than some RSRP change threshold. If the RSRP of the candidate cell 301b does not change significantly (e.g., change is less than the RSRP threshold, or otherwise does not satisfy the RSRP change threshold), then the UE 120 may determine that the individual TA for the candidate cell 301b or the common TA 325 for the C-TAG 330 remains valid. Conversely, if the RSRP of the candidate cell 301bchanges significantly (e.g., change is greater than the RSRP threshold, or otherwise satisfies the RSRP change threshold), then the UE 120 may determine that the individual TA for the candidate cell 301b or the common TA 325 for the C-TAG 330 is no longer valid.

Additionally, or alternatively, the UE 120 may determine that individual TAs or the common TA 325 are valid according to a validation timer (e.g., TA is valid if the corresponding validation timer has not yet expired). That is, a validation timer may indicate for how long a TA is valid (e.g., whether a transmission would be time aligned if the TA is used some time from when the TA was indicated). In some cases, the UE 120 may determine whether or not the common TA 325 is valid by evaluating a single validation timer associated with the common TA 325. Additionally, or alternatively, the UE 120 may determine whether or not the common TA 325 is valid by evaluating separate validation timers associated with the individual TAs of the respective candidate cells 301b, 301c, 301d.

The UE 120 may determine whether the common TA 325 (or an individual TA) is valid based on the validation timer, the RSRP change threshold, or both. That is, in some examples, the UE 120 may determine a validity or an invalidity of the common TA 325 according to the validation timer (e.g., without the RSRP change threshold). In some other examples, the UE 120 may determine a validity or an invalidity of the common TA 325 according to the RSRP change threshold (e.g., without the validation timer). Alternatively, the UE 120 may determine the validity or the invalidity of the common TA 325 according to both the validation timer and the RSRP change threshold.

In some examples, the UE 120 may declare an invalid common TA 325 for the C-TAG 330 (e.g., declare the common TA 325 invalid) based on a threshold quantity of cells 301 having expired validation timers, satisfying RSRP change thresholds, or both. For example, the UE 120 may declare an invalid common TA 325 for the C-TAG 330 based on at least one candidate cell 301 (e.g., all candidate cells, or a threshold quantity/percentage of candidate cells 301) within the C-TAG 330 having invalid individual TAs.

The UE 120 may transmit a report 335 to indicate the invalid common TA 325 for the C-TAG 330. For example, based on declaring the invalid common TA 325 for the C-TAG 330, the UE 120 may transmit a report 335 (e.g., a MAC-CE report) to the serving cell 301ato inform the serving cell 301a of the invalid common TA 325 for the C-TAG 330. The report 335 may include the C-TAG ID, a list of candidate cell IDs for which invalid individual TAs are detected, a list of one or more SSBs for candidate cells with invalid individual TAs (e.g., to prepare a possible PDCCH-ordered RACH), a list of candidate cell IDs for which valid individual TAs are present, a list of valid individual TA values, or any combination thereof. In other words, the report 335 may indicate invalid individual TAs that caused the common TA 325 to be invalid. The UE 120 may transmit the report 335 in accordance with a timer (e.g., prohibit timer). For example, the UE 120 may restart the timer after transmitting the report 335 and retransmit the report when the timer expires (e.g., to avoid frequent transmissions).

In some examples, the UE 120 may autonomously transmit a request for the command 310 to initiate a RACH procedure (e.g., a PDCCH-ordered RACH request) for a candidate cell 301 in the C-TAG 330 according to a prohibit timer. For example, the UE 120 may reset the prohibit timer after transmitting the request and, after the prohibit timer expires, retransmit the request. In some examples, the request may include an ID of the C-TAG 330, one or more IDs of candidate cells 301, one or more SSB indices, or a combination thereof. The UE 120 may transmit the request via an uplink control information (UCI) message or via a MAC-CE message. In examples in which the UE 120 transmits the request via the UCI message, the UE 120 may use a dedicated scheduling request or UCI resource that is configured for the C-TAG 330. That is, the UE 120 may use the dedicated scheduling request or UCI resource such that the serving cell 301a may identify that the UE 120 is requesting the command 310 for the C-TAG 330.

In some examples, in addition to transmitting the request according to a prohibit timer, the UE 120 may transmit the request according to a priority rule. For example, the UE 120 may transmit the request and, while waiting for a response, an SSB included in the request may have decreased performance compared to another SSB that may be used for the RACH. For example, after transmitting the request indicating a first SSB associated with the candidate cell 301b, a second SSB may become better than the first SSB. Accordingly, the UE 120 may transmit another request that indicates the second SSB (e.g., regardless of whether the prohibit timer has expired).

As indicated above, FIG. 3 is provided as an example. Other examples may differ from what is described with respect to FIG. 3.

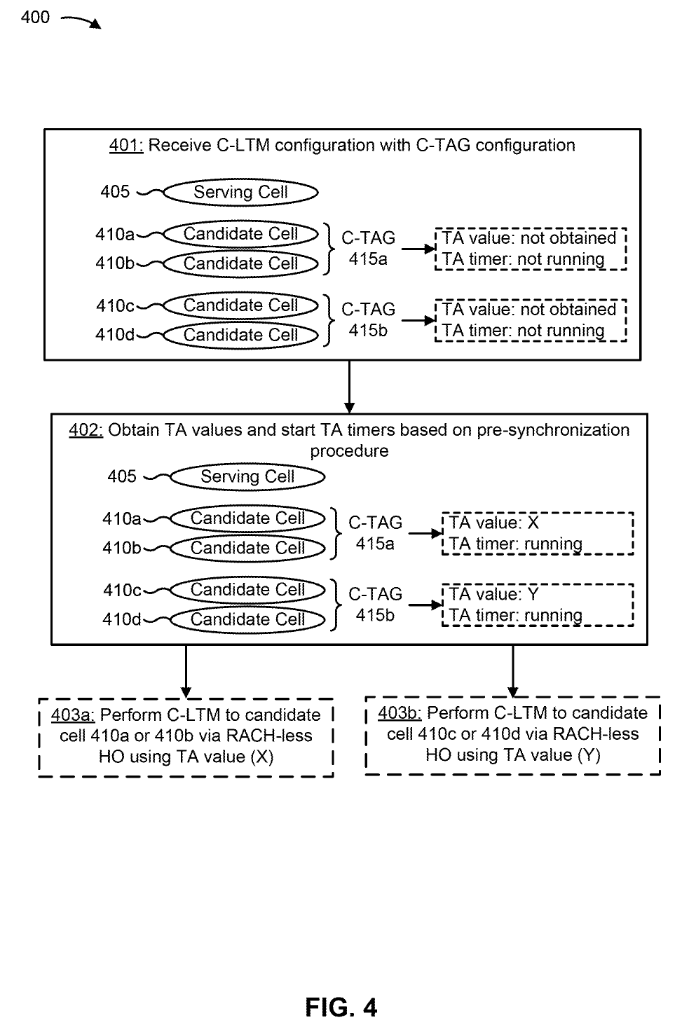

FIG. 4 is a diagram illustrating example 400 of C-TAG management in C-LTM for a RACH-less handover. In some instances, example 400 may implement or be implemented by one or more aspects of FIGS. 1 through 3. For instance, the example 400 may include one or more operations performed by a UE 120 in accordance with a C-LTM configuration and a C-TAG configuration, as described elsewhere herein (e.g., with reference to FIG. 3). Additionally, a serving cell 405, candidate cells 410, and C-TAGs 415 may be respective examples of the serving cell 301a, the candidate cells 301b, 301c, and 301d, and the C-TAG 330.

In a first operation 401, a serving cell 405 may transmit, and the UE 120 may receive, a control message that indicates one or more C-TAG indications (e.g., C-TAG indication 305 included in the control message, with reference to FIG. 3). In some examples, the one or more C-TAG indications may configure the UE 120 with a C-TAG 415athat includes candidate cells 410a and 410b, and configure the UE 120 with a C-TAG 415b that includes candidate cells 410c and 410d. However, in other examples, the serving cell 405 may configure the UE 120 with any number of C-TAGs 415 that include any number of candidate cells 410. Additionally, the control message may further indicate a first common TA timer for C-TAG 415a and a second common TA timer for C-TAG 415b.

In a second operation 402, the UE 120 may obtain TA values and start the TA timers for the C-TAGs 415aand 415b in accordance with performing a pre- synchronization procedure. The UE 120 may perform the pre-synchronization procedure before the UE 120 establishes or re-establishes a connection with a candidate cell 410 (e.g., during handover or cell reselection).

In some examples, as part of the pre-synchronization procedure, the UE 120 may measure the signal quality of one or more of the candidate cells 410 and report the measurements to the serving cell. For example, the UE 120 may measure one or more of reference signal received power (RSRP), reference signal received quality (RSRQ), or signal-to-interference-plus-noise ratio (SINR), among other examples. The UE 120 may transmit the signal quality measurements via a measurement report based on an event or a triggering condition defined by the network. For example, the network may configure the UE 120 to report when the RSRP of a candidate cell 410 exceeds a certain threshold or when the RSRQ of the serving cell falls below a certain level.

Based on the measurements, the serving cell 405 may transmit, and the UE 120 may receive, a command to perform pre-synchronization with one or more candidate cells. For example, the command may be transmitted via an RRC or MAC signaling and include the C-TAGs 415a and 415b. Additionally, the command may indicate information associated with one or more candidate cells 410, synchronization signals, and timing advance parameters.

In accordance with receiving the command, the UE 120 may synchronize with one or more of the candidate cells 410 by obtaining the TA values. Obtaining the TA values may involve receiving synchronization signals (e.g., primary synchronization signal (PSS) and secondary synchronization signal (SSS)) and decoding the information to calculate the TA value. In some examples, the UE 120 may receive synchronization signals from a single candidate cell 410 in a given C-TAG 415 to determine the common TA value for the given C-TAG 415. For example, the UE 120 may receive synchronization signals from the candidate cell 410a and determine a first common TA value of X for the C-TAG 415a, and the UE 120 may receive synchronization signals from the candidate cell 410c and determine a second common TA value of Y for the C-TAG 415b. After the UE 120 obtains the common TA values for C-TAGs 415a and 415b, the UE 120 may start the first common TA timer for C-TAG 415aand the second common TA timer for C-TAG 415b.

In a third operation 403, the UE 120 may perform a RACH-less handover to one of the candidate cells 410. For example, the RACH-less handover may be a handover procedure that eliminates the need for the UE 120 to perform random access in a given candidate cell 410. Rather, the UE 120 may use the pre-synchronized information and directly access the given candidate cell 410. Accordingly, the RACH-less handover may reduce handover latency, improve reliability, and enhance the overall user experience by enabling seamless connectivity during mobility events. If the UE 120 performs a third operation 403a, then the UE 120 may connect to one of candidate cell 410aor candidate cell 410b in accordance with the first common TA value of X. If the UE 120 performs a third operation 403b, then the UE 120 may connect to one of candidate cell 410c or candidate cell 410d in accordance with the second common TA value of Y.

As indicated above, FIG. 4 is provided as an example. Other examples may differ from what is described with respect to FIG. 4.

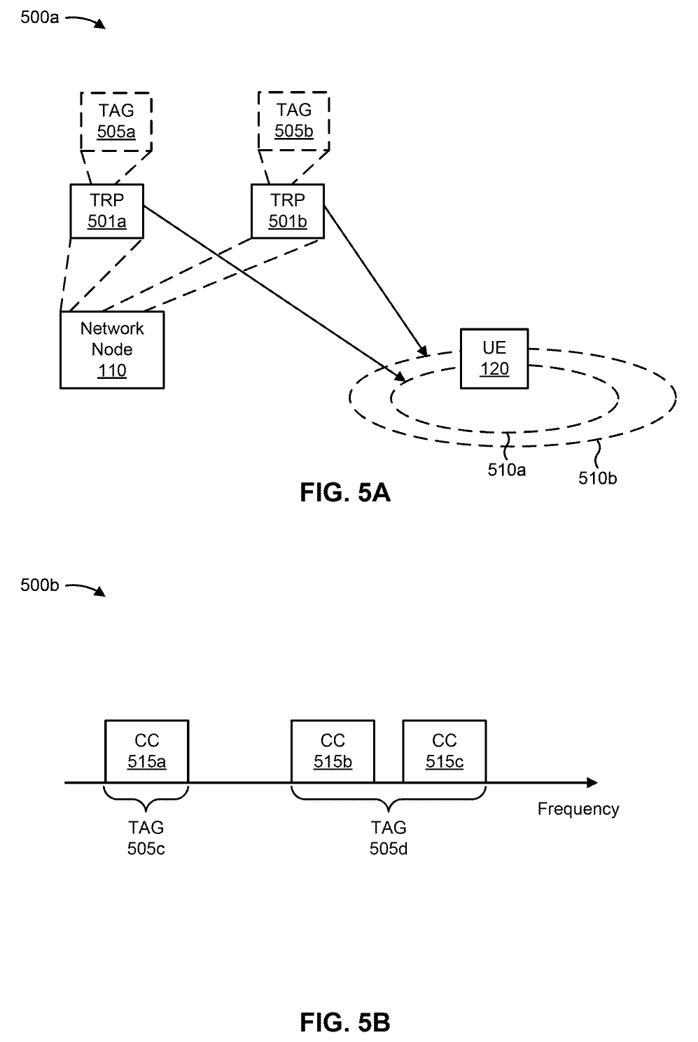

FIGS. 5A and 5B are diagrams illustrating examples 500a and 500b of TAG management for uplink carrier aggregation. In some instances, examples 500aand 500bmay implement or be implemented by one or more aspects of FIGS. 1 through 4.

Examples 500a and 500b may be associated with multiple TA configurations for uplink carrier aggregation. For example, multiple TA configurations may support uplink carrier aggregation with component carriers (CCs) that have different propagation characteristics, such as varying frequencies and transmission reception points (TRPs). Accordingly, multiple TA configurations may allow for more efficient and effective management of uplink transmissions when dealing with multiple carriers that may experience different delays and propagation conditions. In multiple TA configurations, one or more CCs or one or more serving cells may be grouped into multiple TAGs.

As shown in FIG. 5A, a network node 110 may include multiple TRPs 501 (e.g., TRP 501a and 501b). The network node 110 may include any number of TRPs that service the UE 120. Additionally or alternatively, multiple TRPs 501 may be respectively associated with multiple network nodes 110 that service the UE 120. “TRP” may refer to a specific location or node equipped with one or more antennas and radio equipment that may transmit and receive signals to and from the UE 120. TRPs 501 may be strategically placed to enable optimal coverage, capacity, and performance within the network. Additionally, TRPs 501 may manage the propagation characteristics of signals, handling multiple frequency carriers, and supporting various communication technologies to enhance overall network efficiency and user experience. In some examples, different TRPs 501 may correspond to different cells 510 within a network. For instance, a given TRP 501 may serve as a distinct point of communication, covering a specific geographical area known as a cell 510. As shown in FIG. 5A, the TRP 501a covers a cell 510a and the TRP 501b covers the cell 510b. The cells 510 can vary in size and coverage depending on factors such as the network design, frequency used, and the environment. In some examples, the cells 510 may be an example of any other cell described herein (e.g., a serving cell, a candidate cell, among other examples). As shown in FIG. 5B, each TRP 501 may be mapped to a TAG 505 which may be associated with a TAG-ID. For example, the TRP 501amay be mapped to a TAG 505aand the TRP 501b may be mapped to a TAG 505b. In some other examples, multiple TRPs 501 or multiple serving cells may be mapped to or included in a same TAG 505.

As shown in FIG. 5B, multiple CCs 515 (e.g., CC 515a, 515b, and 515c) may be configured for wireless communications (e.g., between the UE 120 and the network node 110). A CC 515 may be a frequency band allocated for wireless communication between the network and user devices. Each CC 515 may include a set of contiguous or non-contiguous frequency resources that can be used for transmitting and receiving data. In some examples, the network node 110 or UE 120 can aggregate multiple CCs 515 to form a wider bandwidth, thereby increasing data rates and overall network capacity. In some examples, a CC 515 may be associated with a cell 510. For example, a cell 510, defined by the associated geographical coverage area, may be served by one or more CCs 515. These one or more CCs 515 provide the frequency resources for communication within that cell 510. By managing multiple CCs 515, a cell 510 can support higher data throughput and better handle the demands of multiple users. As shown in FIG. 5B, one or more CCs 515 may be mapped to or included in a TAG 505 associated with a TAG-ID. For example, a TAG 505cmay be mapped to or include the CC 515a, and the TAG 505d may be mapped to or include a CC 515band 515c. In other words, multiple CCs 515 or serving cells may be mapped to or included in a same TAG 505.

As described herein, serving cells, TRPs 501, and CCs 515 may be organized into one or more TAGs 505. For example, each TAG 505 may include one or more CCs 515 or serving cells that share similar TA characteristics. The mapping of CCs 515 or serving cells to a specific TAG may be identified by a TAG-ID, which may be configured through control signaling (e.g., via an RRC protocol). For example, the network node 110 may transmit, and the UE 120 may receive, control signaling that indicates one or more CC-IDs, one or more TRP-IDs, or one or more serving cell-IDs, and identifies a TAG-ID to map to. For each TAG 505, a TA value and TA timer may be maintained, enabling synchronization of uplink transmissions within that TAG.

Additionally, the network node 110 may transmit, and the UE 120 may receive, a TA command (e.g., via MAC-CE or L1 signaling). In some examples, the TA command may specify a TA value or a TA range for a particular TAG 505 by referencing the associated TAG-ID. This mechanism allows for efficient management of timing adjustments across different groups of carriers and cells, optimizing overall network performance and reliability. For instance, a TA command may indicate the TAG-ID for the TAG 505aand indicate an update to the TA timer or the TA value for the TAG 505a.

As indicated above, FIGS. 5A and 5B are provided as examples. Other examples may differ from what is described with respect to FIGS. 5A and 5B.

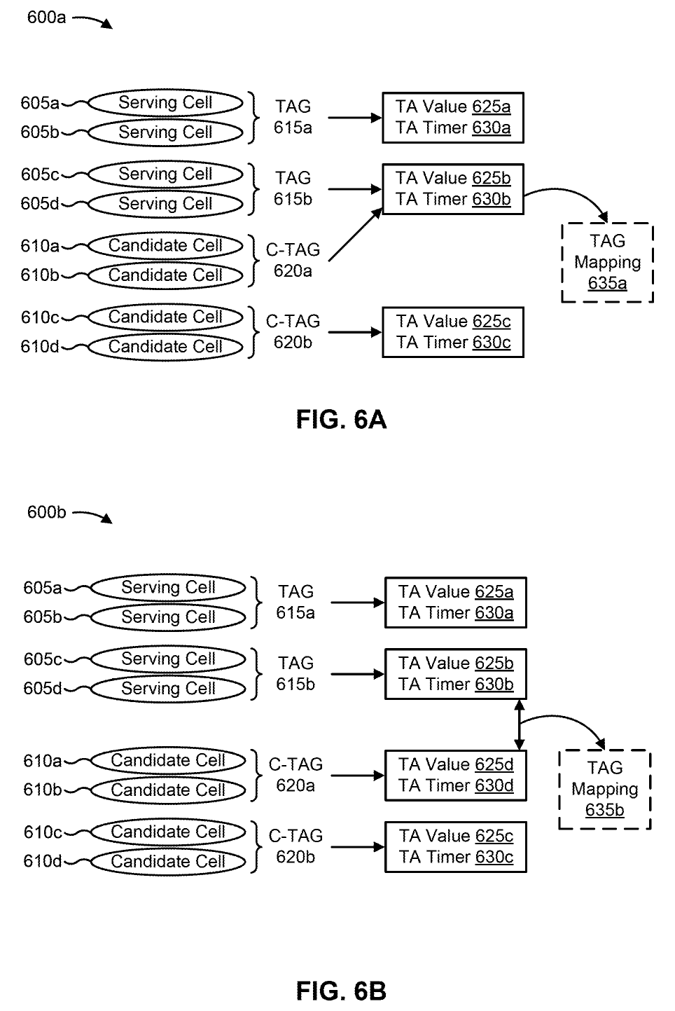

FIGS. 6A and 6B are diagrams illustrating examples 600a and 600b of TAG mapping to enable skipping of an uplink synchronization procedure. In some instances, examples 600aand 600bmay implement or be implemented by one or more aspects of FIGS. 1 through 5. For example, FIGS. 6A and 6B illustrate serving cells 605 and candidate cells 610, which may be respective examples of serving cells and candidate cells described elsewhere herein. Additionally, FIGS. 6A and 6B illustrate an example configuration of serving cells 605 that service the UE 120 and an example configuration of candidate cells 610 that the UE 120 may connect with after performing a handover procedure (e.g., a C-LTM procedure).

As shown in FIGS. 6A and 6B, the UE 120 is configured with a set of serving cells 605 that are included in multiple TAGs 615. For instance, serving cells 605a and 605b may be included or mapped to a TAG 615a and serving cells 605c and 605d may be included or mapped to a TAG 615b. The TAGs 615 may be examples of the TAGs 505, as described with reference to FIG. 5. In some examples, the serving cells 605 may include different types of serving cells, including one or more of a primary cell (PCell), a secondary cell (SCell), or a primary-secondary cell (PSCell). A PCell may be the main serving cell that a UE 120 connects to for initial access and primary communication with the network node 110. For example, the PCell may handle control signaling and manage the overall connection. The SCell may be an additional serving cell that the UE 120 connects to for the purpose of increasing data throughput. For example, the SCell may work in conjunction with the PCell to provide additional bandwidth and improve data rates. A PSCell may be a hybrid cell used in dual connectivity (DC) scenarios, where a UE 120 may be concurrently connected to two different network nodes 110 (e.g., a first network node 110 that supports LTE and a second network node 110 that supports 5G NR). For example, a PSCell may serve as the PCell for a secondary connection in DC scenarios, managing control signaling and data transfer for the associated link. Together, the different types of serving cells enable more efficient and higher-capacity communication in wireless networks.

As shown in FIGS. 6A and 6B, a TAG 615 may be configured with a TA value 625 (described elsewhere herein) and a TA timer 630 (described elsewhere herein). For example, the TAG 615amay be configured with a TA value 625a and a TA timer 630a, and the TAG 615b may be configured with a TA value 625b and a TA timer 630b. The network node 110 may configure the UE 120 with the TAGs 615 and the corresponding TA values 625 and TA timers 630 during an initial connection setup. For example, when the UE 120 initially establishes a connection with the network node 110, the network node 110 may assign TAGs 615 (and the associated TA values 625 and TA timers 630) to the serving cells 605 (e.g., via an RRC signaling). In some examples, after the initial connection setup, the network node 110 may transmit a TA command (described elsewhere herein) to update one or more TA values 625 or one or more TA timers 630 for one or more TAGs 615.

As shown in FIGS. 6A and 6B, the UE 120 is configured with a set of candidate cells 610 that are included in multiple C-TAGs 620. For instance, candidate cells 610a and 610b may be included or mapped to a C-TAG 620a, and candidate cells 610c and 610d may be included or mapped to a C-TAG 620b. The C-TAGs 620 may be examples of the C-TAG 330 or the C-TAGs 415, as described with reference to FIGS. 3 and 4, respectively.

As shown in FIGS. 6A and 6B, a given C-TAG 620 may be configured with a TA value 625 and a TA timer 630. For example, the C-TAG 620bmay be configured with a TA value 625cand a TA timer 630c. As described elsewhere herein, the network node 110 may configure the UE 120 with the C-TAGs 620 and the TA timers 630 via one or more C-TAG indications (e.g., C-TAG indication 305). Accordingly, the UE 120 may determine a respective TA value 625 for each C-TAG 620 by performing a pre-synchronization procedure. For example, the UE 120 may determine the TA value 625cby performing a pre-synchronization procedure with a candidate cell 610 included in the C-TAG 620b(e.g., candidate cell 610cor 610d). However, performing a pre- synchronization procedure with one or more candidate cells 610 may result in interruption in communication with the serving cells 605, which may result in a reduction in data throughput (e.g., as the number of pre-synchronization procedures increases, the data throughput decreases). Additionally, C-TAG configurations may enable the UE 120 to reduce the number of pre-synchronization procedures from being on a per candidate cell 610 basis to being on a per C-TAG 620 basis; however, the UE 120 may still perform at least one pre-synchronization procedure.

According to the techniques described herein, the UE 120 and network node 110 may be able to skip or further reduce the number of pre-synchronization procedures by using a TAG mapping 635. For example, the network node 110 may transmit, and the UE 120 may receive, mapping information (e.g., TAG mapping 635) that indicates for the UE 120 to associate a TAG 615 with a C-TAG 620. Accordingly, with reference to the TAG mapping 635, the UE 120 may apply a TA value 625 of a TAG 615 to the mapped C-TAG 620 (or vice versa). For instance, in some examples, a given C-TAG 620 (or one or more candidate cells 610) may have the same or similar propagation characteristics as a given TAG 615 (e.g., same or similar frequency band, among other examples). In such examples, the network node 110 and the UE 120 may skip a pre-synchronization procedure for the given C-TAG 620 by utilizing the TA value 625 of the given TAG 615.

As shown in FIG. 6A, a TAG mapping 635a may indicate a mapping between the TAG 615band the C-TAG 620a. For example, the TAG mapping 635amay indicate that C-TAG 620a shares the TA value 625band the TA timer 630b configured for the TAG 615b. In other words, the TA value 625band the TA timer 630b may be examples of a common TA value and a common TA timer shared between the TAG 615band the C-TAG 620a. Accordingly, if the UE 120 determines to handover to candidate cell 610a or candidate cell 610b, then the UE 120 may skip a pre-synchronization procedure for the C-TAG 620a and perform a RACH-less handover procedure to candidate cell 610a or candidate cell 610b using the TA value 625b. Therefore, the TAG mapping 635amay enable the UE 120 to skip a pre-synchronization procedure, which may reduce latency and complexity associated with performing a handover procedure using the TA value 625b. Additionally, based on TAG mapping 635a indicating a common TA value and a common TA timer, the network node 110 may not have to indicate a separate TA value and TA timer for the C-TAG 620a, reducing signaling overhead and complexity. Additionally, the TAG mapping 635a may be advantageous in scenarios where the TAG 615b and the C-TAG 620ainclude serving cells 605 and candidate cells 610 at a single network node 110 (e.g., rather than separate network node 110s).

As shown in FIG. 6B, a TAG mapping 635b may indicate a mapping between the TAG 615b and the C-TAG 620a. Conversely to example 600a, however, the network node 110 may configure separate or independent TA values and TA timers for the TAG 615b and the C-TAG 620a. For example, the network node 110 may configure the C-TAG 620a with a TA value 625d and a TA timer 630d. In some examples, the TAG mapping 635b may be applied to the TAG 615band the C-TAG 620a based on the TA value 625b and the TA value 625d being the same TA value or based on the difference between the TA value 625b and the TA value 625d satisfying a TA difference threshold. Additionally, the TAG mapping 635b may enable updates to the TA value 625b or to the TA timer 630b to result in updates to the TA value 625d or to the TA timer 630d (or vice versa). Accordingly, if the UE 120 determines to handover to candidate cell 610a or candidate cell 610b, the UE 120 may skip a pre-synchronization procedure for the C-TAG 620a and perform a RACH-less handover procedure to candidate cell 610a or candidate cell 610b using the TA value 625d. Therefore, the TAG mapping 635b may enable the UE 120 to skip a pre-synchronization procedure, which may reduce latency and complexity associated with performing a handover procedure. Additionally, the TAG mapping 635b may increase flexibility in the network node 110 indicating separate TA timers across different TAGs and C-TAGs. Additionally, the TAG mapping 635b may be advantageous in scenarios where the TAG 615b and the C-TAG 620a include serving cells 605 and candidate cells 610 across multiple network nodes 110 (e.g., rather than a single network node 110).

While FIGS. 6A and 6B show TAG mappings 630 that map a single C-TAG 620 to a single TAG 615, in other examples, a TAG mapping 635 can map multiple C-TAGs 620 to a single TAG 615, map multiple candidate cells 610 to a single TAG 615, map multiple C-TAGs 620 to a single serving cell 605, or map multiple candidate cells 610 to a single serving cell 605.

As indicated above, FIGS. 6A and 6B are provided as examples. Other examples may differ from what is described with respect to FIGS. 6A and 6B.

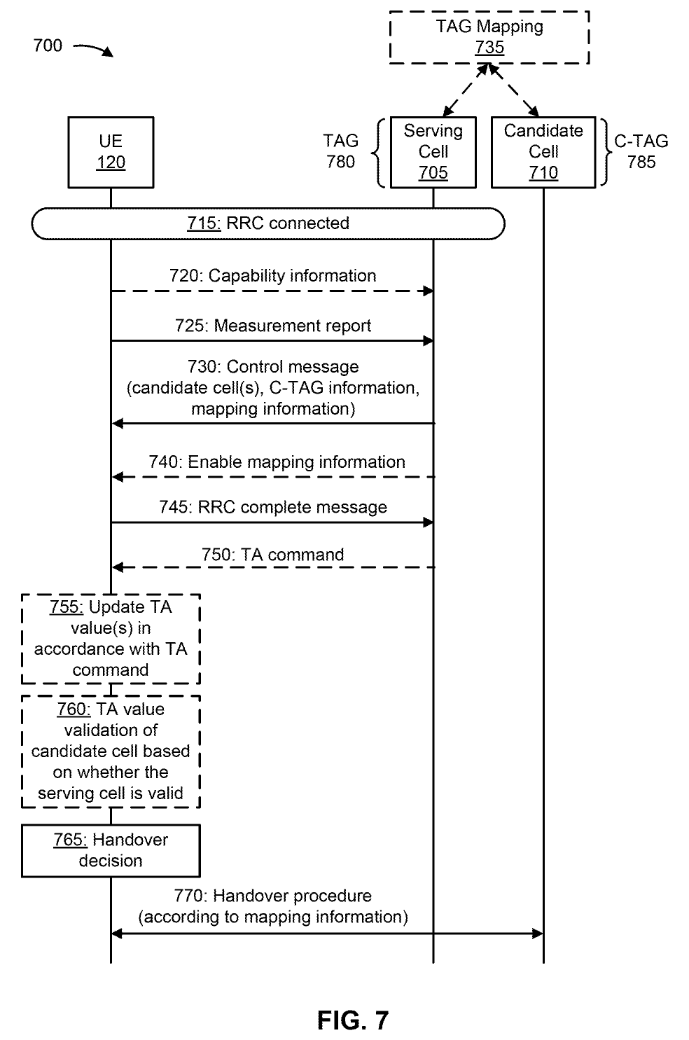

FIG. 7 is a diagram illustrating an example 700 associated with signaling that enables serving-cell-to-candidate-cell TAG mapping. Example 700 may implement or be implemented by one or more aspects of FIGS. 1 through 6B. For instance, example 700 includes wireless communications between the UE 120 and a serving cell 705 and a candidate cell 710. The serving cell 705 and candidate cell 710 may be examples of other serving cells and candidate cells described elsewhere herein. Alternative examples of the following may be implemented, where some operations are performed in a different order than described, or not described at all. In some cases, one or more operations may include additional features not mentioned below, or further operations may be added. In addition, while example 700 shows operations between the UE 120, the serving cell 705, and the candidate cell 710, the communications may occur between any number of network devices of various types described herein. For example, the UE 120 may perform one or more of the operations of example 700 in accordance with multiple serving cells 705 or multiple candidate cells 710.

In a first operation 715, the UE 120 may connect to the serving cell 705 through a series of steps that establish a communication link between the UE 120 and the cellular network such that the UE 120 is in an RRC connected state with the serving cell 705. Initially, the UE 120 may scan for available networks and select the serving cell 705 based on signal strength or quality. Based on selecting the serving cell 705, the UE 120 may perform an initial access procedure, which may involve synchronization with the timing of the serving cell 705, followed by the transmission of a random access preamble to request network access. The serving cell 705 may respond with a random access response, providing the UE 120 with information to establish a connection (such as timing adjustments and resource allocations). The UE 120 may complete the connection setup by exchanging further signaling messages, including authentication and security procedures, to enable a secure and reliable communication link. Being connected to the serving cell 705 means that the UE 120 can now send and receive wireless messages through the network, maintaining continuous communication as it moves within a coverage area of the serving cell 705. In some examples, the UE 120 may determine a TA value and TA timer of the serving cell 705, as part of the first operation 715. In some examples, the network (e.g., via a network node 110 that includes the serving cell 705) may configure the UE 120 with one or more TAGs that include one or more serving cells. For example, the serving cell 705 may be included in the TAG 780.

In a second operation 720, the UE 120 may optionally transmit, and the serving cell 705 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective information elements (IEs) included in a capability report. The capability information may indicate whether the UE 120 supports a feature or one or more parameters related to the feature.

In some examples, the capability information may indicate a number of TAGs supported for candidate cells (e.g., a number of supported C-TAGs). In other words, the UE 120 may indicate a number of C-TAGs supported for C-LTM.

Additionally, or alternatively, the capability information may indicate a first number of TAGs supported for serving cells and a second number of C-TAGs supported for candidate cells. If the same number of TAGs for serving cells (e.g., TAGs for uplink CA) can be supported as the number of C-TAGs, then the capability information may indicate a single number that indicates the first number of TAGs and the second number of C-TAGs. In some examples, the capability information may indicate a number of TAGs for serving cells supported and a number indicating a difference between the number of TAGs for serving cells and the number of C-TAGs for candidate cells (e.g., #TAG – #C-TAG). In some examples, the capability information may explicitly indicate the first number of TAGs supported for serving cells and the second number of C-TAGs supported for candidate cells. In some examples, the capability information may indicate a total combined number for both TAGs for serving cells and C-TAGs for candidate cells (e.g., if the capability indicates 8, then the sum of TAGs for serving cells and C-TAGs for candidate cells configured at the UE 120 should be less than or equal to 8).

Additionally, or alternatively, the capability information may indicate one or more groups of frequency bands supported for one or more C-TAGs associated with candidate cells. In some examples, the capability information may explicitly indicate the one or more frequency groups. In some examples, the capability information may include a bit that indicates whether the UE 120 supports a C-TAG on a per frequency band basis. In some examples, the capability information may include a bit that indicates whether the UE 120 supports fully flexible C-TAGs (e.g., C-TAGs that can be used across the configured frequency bandwidth).

Additionally, or alternatively, the capability information may be indicated per UE 120, and may indicate support for C-TAGs for one or more of one or more frequency band combinations, one or more feature sets, one or more frequency bands, one or more RATs, one or more wireless system types, or one or more NTN orbit types.

One or more operations described herein may be based on the capability information. For example, the UE 120 may perform one or more operations of example 700 in accordance with the capability information or may receive one or more of configuration information or control information that is in accordance with the capability information. The serving cell 705 may determine configuration information for the UE 120 based on the capability information. For example, the serving cell 705 may determine a TAG capability for C-LTM for the UE 120 based on the capability information.

In a third operation 725, the UE 120 may transmit, and the serving cell 705 may receive, a measurement report (e.g., as described by reference number 210). For example, the measurement report (sometimes referred to as a MeasurementReport), may be an L3 measurement report. The measurement report may indicate signal strength measurements (e.g., RSRP, RSSI, RSRQ, or CQI) or similar measurements associated with the serving cell 705 or one or more neighboring cells (e.g., one or more potential candidate cells).

In a fourth operation 730, the serving cell 705 may transmit, and the UE 120 may receive, the configuration information via a control message. In some aspects, the UE 120 may receive the configuration information via one or more of system information signaling (e.g., a master information block (MIB) or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the serving cell 705 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information included in the control message may configure one or more candidate cells (e.g., including the candidate cell 710), information identifying one or more C-TAGs to which the one or more candidate cells belong (e.g., indicate that candidate cell 710 belongs to the C-TAG 785), and mapping information that identifies a mapping between one or more TAGs for serving cells and one or more of the C-TAGs. For example, the mapping information may indicate a TAG mapping 735 between the TAG 780 and the C-TAG 785. In some examples, the control message may include one or more aspects of an LTM candidate configuration (e.g., reference number 220) or one or more aspects of the C-TAG indication 305. In some examples, the C-TAG information and the mapping information may be outside of a C-LTM configuration (e.g., separate control signaling).

In some examples, the configuration information in the control message may include information to enable C-LTM for the UE 120, such as lower layer configuration and execution conditions. The execution conditions may be criteria that, if met, may enable the UE 120 to initiate handover to the candidate cell 710. For instance, one execution condition for C-LTM may be based on signal strength thresholds (e.g., RSRP, RSRQ, or SINR, among other example). If the signal strength of the serving cell 705 falls below a predefined threshold while the signal strength of a neighboring candidate cell exceeds a certain level, the UE 120 may trigger the handover process. Accordingly, the UE 120 may maintain a strong and reliable connection by switching to a cell with better signal quality. Another example of an execution condition may involve quality of service (QoS) parameters. If QoS metrics, such as latency or packet loss, degrade beyond acceptable limits in the serving cell 705, the UE 120 may initiate a handover to a neighboring cell that can provide better QoS. Additionally, execution conditions may be based on mobility patterns and UE 120 speed. For example, if the UE 120 is moving at a speed greater than or equal to a speed threshold, the network may preemptively trigger handovers to the candidate cell 710 along with a predicted path of the UE 120 to avoid connection drops and ensure continuous service. This predictive handover mechanism is helpful in scenarios such high-speed trains or vehicles where rapid cell transitions occur. In some cases, the execution condition may involve load balancing. If the serving cell 705 becomes heavily loaded, the serving cell 705 can trigger (e.g., via an RRC, MAC-CE, or DCI signaling) a handover to a less congested neighboring cell (e.g., the candidate cell 710) to distribute the traffic more evenly and maintain overall network performance.

In some examples, the mapping information identifies the mapping between the TAG 780 and the C-TAG 785 based on indicating a first ID that points to the serving cell 705 and a second ID that points to the candidate cell 710. In some examples, the first ID may be a TAG-ID for the TAG 780 or may be a serving cell-ID of the serving cell 705. In some examples, the second ID may be a C-TAG-ID for the C-TAG 785 or may be a candidate-ID of the candidate cell 710.

In some examples, the mapping information may not explicitly indicate the first ID that points to the serving cell 705. In such examples, the mapping information may indicate the second ID that points to the candidate cell 710, and accordingly the UE 120 may map the C-TAG 785 to a specific tag based on a configured characteristic. For example, the UE 120 may be configured to map the C-TAG 785 to a TAG from one or more serving cell TAGs that has the smallest or largest TAG-ID, or map the C-TAG 785 to a serving cell TAG that includes a serving cell 705 with the smallest or largest serving cell -ID.

In some examples, the control message in the fourth operation 730 may configure and enable the mapping information (e.g., enable the TAG mapping 735).

In a fifth operation 740, the serving cell 705 may optionally transmit, and the UE 120 may receive, control information that enables the mapping information. For example, the control message may configure the mapping information and then, at a later time, the control information may enable the UE 120 to operate in accordance with the mapping information (e.g., enable the TAG mapping 735). In some examples, the control information may be transmitted via a MAC-CE message or via a DCI message.

In accordance with one or more of the fourth operation 730 or the fifth operation 740, the TAG mapping 735 may be enabled.

In some examples, the TAG mapping 735 may be an example of the TAG mapping 635a. For example, the mapping information may indicate that the C-TAG 785 shares a TA timer and a TA value with the TAG 780. In other words, if a TA value of the TAG for the serving cell 705 is valid (e.g., TA timer is running), then the TA value of the C-TAG is considered valid.

In some examples, the TAG mapping 735 may be an example of the TAG mapping 635b. For example, the TAG 780 may have a first TA timer and a first TA value and the C-TAG 785 may have a second TA timer and a second TA value, where the mapping information may indicate that updates to the first TA timer and the first TA value apply to the second TA timer and the second TA value (or vice versa).

In a sixth operation 745, the UE 120 may transmit, and the serving cell 705 may receive, an RRC complete message. In some examples, the RRC complete message may include one or more aspects of the RRC reconfiguration complete message of reference number 225. In some examples, the RRC complete message may indicate preferred mapping information. For example, the UE 120 may request a change in the TAG mapping 735 to map the TAG 780 to a different C-TAG or vice versa, or to map an additional C-TAG to the TAG 780. If the serving cell 705 accepts the preferred mapping information, then the serving cell 705 may transmit, and the UE 120 may receive, an indication that the UE 120 should use the preferred mapping information. If the serving cell 705 does not accept the preferred mapping information, then the serving cell 705 may transmit, and the UE 120 may receive, an indication that the UE 120 should use the mapping information indicated in the fourth operation 730.

In a seventh operation 750, the serving cell 705 may optionally transmit, and the UE 120 may receive, a TA command, as described elsewhere herein (e.g., via a TA command MAC-CE or a C-LTM MAC-CE). For example, the TA command may update a TA value. In some examples, the TA command may indicate an absolute TA value. In some examples, the TA command may indicate a relative TA value with respect to a current TA value for the TAG 780 or the C-TAG 785.

If the TAG mapping 735 is in accordance with the TAG mapping 635a (e.g., the TAG 780 and the C-TAG 785 share the TA value), then the TA command may indicate a TAG-ID that points to the TAG 780 or a C-TAG ID that points to the C-TAG 785. Accordingly, the TA command may indicate to update the TA value shared between the TAG 780 and the C-TAG 785.

In some other examples of receiving the TA command, the TAG mapping 735 is in accordance with the TAG mapping 635b (e.g., the TAG 780 has a first TA value and a first TA timer and the C-TAG 785 has a second TA value and a second TA timer). Accordingly, if the TA command indicates a TAG-ID that points to the TAG 780, then the UE 120 updates both the first TA value of the TAG 780 and the second TA value of the C-TAG 785. If, however, the TA command indicates a C-TAG-ID that points to the C-TAG 785, then the UE 120 updates the second TA value of the C-TAG 785 and may refrain from updating the first TA value of the TAG 780. In other words, according to the TAG mapping 635b, a TA value update of the serving cell 705 may be obtained by a TA command (or a PRACH) that indicates an ID that directly points to the serving cell 705. Additionally, for the TAG mapping 635b, if the UE 120 obtains the second TA value for the C-TAG 785 while a TA timer of the serving cell 705 is not running (e.g., the first TA timer of the TAG 780 is not running or expired), the UE 120 may still consider the second TA value as valid, if the second TA timer of the C-TAG 785 is still running.

In an eighth operation 755, the UE 120 may optionally update the one or more TA values of TAG 780 and C-TAG 785 in accordance with the TA command of the seventh operation 750.

In a ninth operation 760, the UE 120 may optionally perform TA value validation of the candidate cell 710 based on whether the serving cell 705 is valid. For example, if the serving cell 705 is not valid (e.g., removed from service for the UE 120 via an RRC signaling, deactivated, or in a dormant state), then the UE 120 may consider the TA value of the candidate cell 710 invalid (e.g., consider the associated TA timer expired for the C-TAG 785). In some examples, the UE 120 may check a validity state of one or more serving cells included in the TAG 780 based on a characteristic of the TAG 780 (e.g., the TAG 780 includes a primary serving cell such as the serving cell 705, includes a reference cell, includes a cell indicated by the network, or includes a cell with specific ID, such as a biggest or smallest cell ID of the serving cells that service the UE 120). In some examples, the UE 120 may check validity states of all of the serving cells in the TAG 780 (e.g., if all of the serving cells in the TAG 780 are invalid, then the UE 120 may consider the TA value of the C-TAG 785 invalid).

In a tenth operation 765, the UE 120 may determine a handover decision to handover service from the serving cell 705 to the candidate cell 710. In some examples, the handover decision may be in accordance with the UE 120 identifying that one or more of the execution conditions described herein are satisfied (e.g., as part of C-LTM).

In an eleventh operation 770, the UE 120 may perform a handover procedure between the serving cell 705 and the candidate cell 710 based on the mapping information and the execution condition being satisfied. If the C-TAG 785 has a valid TA value during execution of the handover (as indicated by the TAG mapping 735), then the UE 120 may skip uplink synchronization with the candidate cell 710 and perform a RACH-less handover procedure to the candidate cell 710 using the TA value for the C-TAG 785. If the C-TAG 785 does not have a valid TA value during execution of the handover, then the UE 120 may perform a RACH procedure to establish a connection with the candidate cell 710.

As indicated above, FIG. 7 is provided as an example. Other examples may differ from what is described with respect to FIG. 7.

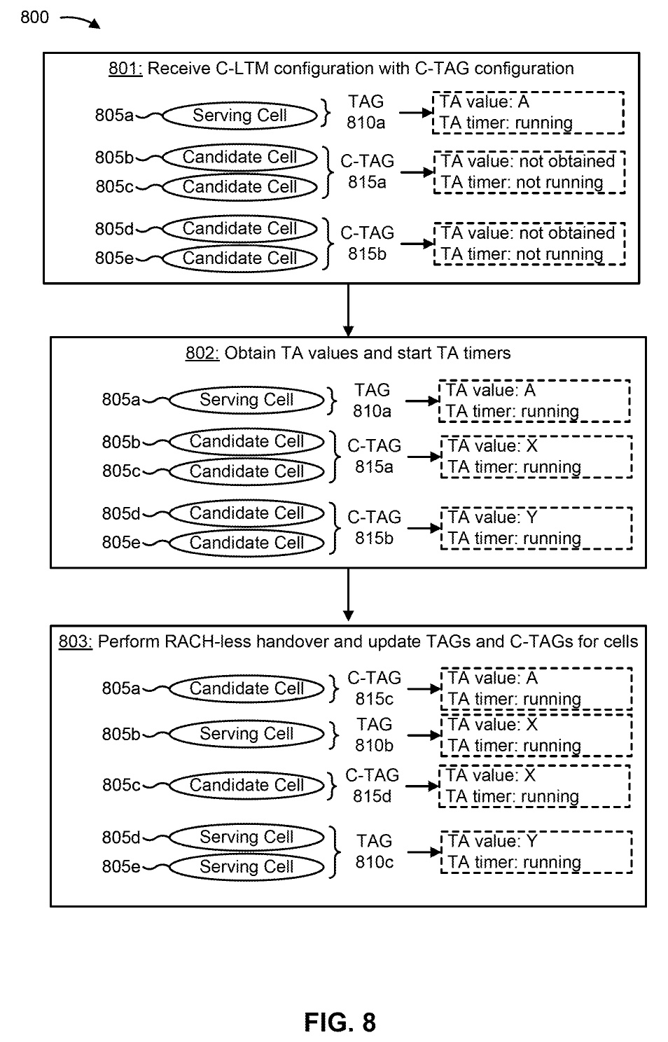

FIG. 8 is a diagram illustrating an example 800 associated with C-TAG and TAG management after a handover. In some instances, the example 800 may implement or be implemented by one or more aspects of FIGS. 1 through 7. For instance, the example 800 may include one or more operations performed by a UE 120 in accordance with a C-LTM configuration and a C-TAG configuration, as described elsewhere herein (e.g., with reference to FIGS. 3 and 7). Additionally, cells 805 (e.g., a cell 805a, 805b, 805c, 805d, and 805e) may be examples of serving cells and candidate cells as described elsewhere herein.

In a first operation 801, the cell 805a (e.g., the serving cell) may transmit, and the UE 120 may receive, a control message that indicates one or more C-TAG indications and mapping information as described elsewhere herein. In some examples, the one or more C-TAG indications may configure the UE 120 with a C-TAG 815athat includes cells 805b and 805c and configures the UE 120 with a C-TAG 815bthat includes cells 805d and 805e. However, in other examples, the serving cell may configure the UE 120 with any number of C-TAGs 815 that include any number of candidate cells. Additionally, the control message may further indicate a first common TA timer for C-TAG 815a(not running) and a second common TA timer for C-TAG 815b(not running). Additionally, as shown in FIG. 8, the cell 805a may be included in a TAG 810athat is configured with a TA value of A and a TA timer that is running.

In a second operation 802, the UE 120 may obtain TA values and start the TA timers for the C-TAGs 815aand 815b in accordance with performing an uplink synchronization procedure (such as a pre-synchronization procedure) or in accordance with mapping information that indicates a TAG mapping between the C-TAG 815aor 815b and the TAG 810a. As shown in FIG. 8, the UE 120 may determine a common TA value of X for the C-TAG 815a and determine a second common TA value of Y for the C-TAG 815b. After the UE 120 obtains the common TA values for C-TAGs 815aand 815b, the UE 120 may start the first common TA timer for C-TAG 815aand the second common TA timer for C-TAG 815b.

In a third operation 803, the UE 120 may perform a RACH-less handover to one or more of the candidate cells (e.g., one or more of cells 805b though 805e). For example, as shown in FIG. 8, the UE 120 may handover to cell 805b (e.g., a PCell) and handover to cells 805d and 805e(e.g., SCells). Additionally, the UE 120 may transition the cell 805a from being a serving cell to being a candidate cell. In other words, after performing the handover, one or more candidate cells may transition to one or more serving cells, one or more serving cells may transition to one or more candidate cells, one or more candidate cells may be maintained as one or more candidate cells, one or more serving cells may be maintained as one or more serving cells, one or more serving cells may transition from a first type of serving cell to a second type of serving cell (e.g., transition from a PCell to an SCell or transition from an SCell to a PCell), or any combination thereof.

In some examples, after the handover procedure, a network node 110 (that includes the current PCell servicing the UE 120) may indicate if or which TA values of the prior cell configuration should be applied after the handover procedure. For example, the network node 110 may transmit, and the UE 120 may receive, control signaling (e.g., one or more of RRC, MAC-CE, or DCI) to indicate one or more of updated C-TAG information, updated TAG information for serving cells, updated TA values, updated TA timers, or updated mapping information (e.g., updated TAG mapping between TAGs and C-TAGs). For instance, as shown in FIG. 8, the control signaling indicates that the cell 805a is included in a C-TAG 815cand maintains the TA value of A, indicates the cell 805b is included in a TAG 810b and maintains the TA value of X, indicates that the cell 805c is included in a C-TAG 815dand maintains the TA value of X, and indicates that the cell 805d and 805e are included in a TAG 810c and maintain the TA value of Y.

As indicated above, FIG. 8 is provided as an example. Other examples may differ from what is described with respect to FIG. 8.

FIG. 9 is a diagram illustrating an example process 900 performed, for example, at a UE or an apparatus of a UE. Example process 900 is an example where the apparatus or the UE (e.g., UE 120) performs operations associated with serving-cell-to-candidate-cell TAG mapping.

As shown in FIG. 9, in some aspects, process 900 may include receiving, from a serving cell belonging to a first TAG, a control message that configures a candidate cell, information identifying a second TAG to which the candidate cell belongs, and mapping information that identifies a mapping between the first TAG and the second TAG (block 910). For example, the UE (e.g., using reception component 1102 or communication manager 1106, depicted in FIG. 11) may receive, from a serving cell belonging to a first TAG, a control message that configures a candidate cell, information identifying a second TAG to which the candidate cell belongs, and mapping information that identifies a mapping between the first TAG and the second TAG, as described above. In some aspects, receiving the control message may be performed in a manner the fourth operation 730 of FIG. 7.

As further shown in FIG. 9, in some aspects, process 900 may include performing a handover between the serving cell and the candidate cell based at least in part on the mapping information (block 920). For example, the UE (e.g., using communication manager 1106, depicted in FIG. 11) may perform a handover between the serving cell and the candidate cell based at least in part on the mapping information, as described above. In some aspects, the handover may be performed in a manner similar the eleventh operation 770 of FIG. 7.

Process 900 may include additional aspects, such as any single aspect or any combination of aspects described below or in connection with one or more other processes described elsewhere herein.

In a first aspect, the handover is a RACH-less handover that skips an uplink synchronization procedure based at least in part on the mapping information indicating that a TA value of the second TAG is valid at a time that the handover is triggered (e.g., as described in connection with FIGS. 2 through 8 ).

In a second aspect, alone or in combination with the first aspect, the mapping information identifies the mapping between the first TAG and the second TAG based at least in part on indicating a first ID that points to the serving cell and a second ID that points to the candidate cell (e.g., as described in connection with FIGS. 2 through 8 ).

In a third aspect, alone or in combination with one or more of the first and second aspects, the serving cell is associated with a smallest or largest TAG ID of a set of TAG IDs, and the mapping information identifies that the second TAG mapped to the first TAG based at least in part on indicating that an ID that points to the candidate cell is mapped to the smallest or largest TAG ID (e.g., as described in connection with FIGS. 2 through 8 ).

In a fourth aspect, alone or in combination with one or more of the first through third aspects, the control message configures and enables the mapping information (e.g., as described in connection with FIGS. 2 through 8 ).

In a fifth aspect, alone or in combination with one or more of the first through fourth aspects, the control message configures the mapping information, and process 900 includes receiving, from the serving cell after receiving the control message, control information that enables the mapping information (e.g., as described in connection with FIGS. 2 through 8 ).

In a sixth aspect, alone or in combination with one or more of the first through fifth aspects, the mapping information indicates that the second TAG shares a TA timer and a TA value with the first TAG (e.g., as described in connection with FIGS. 2 through 8 ).

In a seventh aspect, alone or in combination with one or more of the first through sixth aspects, process 900 includes receiving, from the serving cell, a TA command that updates the TA value based at least in part on indicating a first TAG ID that points to the first TAG or a second TAG ID that points to the second TAG (e.g., as described in connection with FIGS. 2 through 8 ).

In an eighth aspect, alone or in combination with one or more of the first through seventh aspects, the first TAG has a first TA timer and a first TA value and the second TAG has a second TA timer and a second TA value, and the mapping information indicates that updates to the first TA timer and the first TA value apply to the second TA timer and the second TA value (e.g., as described in connection with FIGS. 2 through 8 ).

In a ninth aspect, alone or in combination with one or more of the first through eighth aspects, process 900 includes receiving, from the serving cell, a TA command that updates the first TA value, where the second TA value is updated based at least in part on the updated first TA value based at least in part on the mapping information (e.g., as described in connection with FIGS. 2 through 8 ).

In a tenth aspect, alone or in combination with one or more of the first through ninth aspects, process 900 includes determining a state of the second TA timer based at least in part on the first TA timer in accordance with the mapping information (e.g., as described in connection with FIGS. 2 through 8 ).

In an eleventh aspect, alone or in combination with one or more of the first through tenth aspects, process 900 includes transmitting, to the serving cell, an RRC complete message that indicates preferred mapping information based at least in part on the mapping information (e.g., as described in connection with FIGS. 2 through 8 ).

In a twelfth aspect, alone or in combination with one or more of the first through eleventh aspects, process 900 includes determining that the serving cell is invalid for wireless communications, where a TA value for the candidate cell is invalid based at least in part on the serving cell being invalid and the mapping information (e.g., as described in connection with FIGS. 2 through 8 ).

In a thirteenth aspect, alone or in combination with one or more of the first through twelfth aspects, process 900 includes transmitting, to the serving cell, capability information that indicates a number of TAGs supported for candidate cells (e.g., as described in connection with FIGS. 2 through 8 ).

In a fourteenth aspect, alone or in combination with one or more of the first through thirteenth aspects, process 900 includes transmitting, to the serving cell, capability information that indicates a first number of TAGs supported for serving cells and a second number of TAGs supported for candidate cells (e.g., as described in connection with FIGS. 2 through 8 ).

In a fifteenth aspect, alone or in combination with one or more of the first through fourteenth aspects, process 900 includes transmitting, to the serving cell, capability information that indicates one or more groups of frequency bands supported for one or more TAGs associated with candidate cells (e.g., as described in connection with FIGS. 2 through 8 ).

In a sixteenth aspect, alone or in combination with one or more of the first through fifteenth aspects, process 900 includes transmitting, to the serving cell, capability information that indicates support for one or more TAGs associated with candidate cells, where the support is indicated for one or more of one or more frequency band combinations, one or more feature sets, one or more frequency bands, one or more radio access technologies, one or more wireless system types, or one or more NTN types (e.g., as described in connection with FIGS. 2 through 8 ).

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with serving-cell-to-candidate-cell TAG mapping.

As shown in FIG. 10, in some aspects, process 1000 may include transmitting, to a UE via a serving cell of the network node belonging to a first TAG, a control message that configures a candidate cell, information identifying a second TAG to which the candidate cell belongs, and mapping information that identifies a mapping between the first TAG and the second TAG (block 1010). For example, the network node (e.g., using transmission component 1204 or communication manager 1206, depicted in FIG. 12) may transmit, to a UE via a serving cell of the network node belonging to a first TAG, a control message that configures a candidate cell, information identifying a second TAG to which the candidate cell belongs, and mapping information that identifies a mapping between the first TAG and the second TAG, as described above. In some aspects, transmitting the control message may be performed in a manner the fourth operation 730 of FIG. 7.

Process 1000 may include additional aspects, such as any single aspect or any combination of aspects described below or in connection with one or more other processes described elsewhere herein.

In a first aspect, the mapping information identifies the mapping between the first TAG and the second TAG based at least in part on indicating a first ID that points to the serving cell and a second ID that points to the candidate cell (e.g., as described in connection with FIGS. 2 through 8 ).

In a second aspect, alone or in combination with the first aspect, the serving cell is associated with a smallest or largest TAG ID of a set of TAG IDs, and the mapping information identifies that the second TAG mapped to the first TAG based at least in part on indicating that an ID that points to the candidate cell is mapped to the smallest or largest TAG ID (e.g., as described in connection with FIGS. 2 through 8 ).

In a third aspect, alone or in combination with one or more of the first and second aspects, the control message configures and enables the mapping information (e.g., as described in connection with FIGS. 2 through 8 ).

In a fourth aspect, alone or in combination with one or more of the first through third aspects, the control message configures the mapping information, and process 1000 includes transmitting, to the UE after transmitting the control message, control information that enables the mapping information (e.g., as described in connection with FIGS. 2 through 8 ).

In a fifth aspect, alone or in combination with one or more of the first through fourth aspects, the mapping information indicates that the second TAG shares a TA timer and a TA value with the first TAG (e.g., as described in connection with FIGS. 2 through 8 ).

In a sixth aspect, alone or in combination with one or more of the first through fifth aspects, process 1000 includes transmitting, to the UE, a TA command that updates the TA value based at least in part on indicating a first TAG ID that points to the first TAG or a second TAG ID that points to the second TAG (e.g., as described in connection with FIGS. 2 through 8 ).

In a seventh aspect, alone or in combination with one or more of the first through sixth aspects, the first TAG has a first TA timer and a first TA value and the second TAG has a second TA timer and a second TA value, and the mapping information indicates that updates to the first TA timer and the first TA value apply to the second TA timer and the second TA value (e.g., as described in connection with FIGS. 2 through 8 ).

In an eighth aspect, alone or in combination with one or more of the first through seventh aspects, process 1000 includes transmitting, to the UE, a TA command that updates the first TA value, where the second TA value is updated based at least in part on to the updated first TA value based at least in part on the mapping information (e.g., as described in connection with FIGS. 2 through 8 ).

In a ninth aspect, alone or in combination with one or more of the first through eighth aspects, process 1000 includes receiving, from the UE, an RRC complete message that indicates preferred mapping information based at least in part on the mapping information (e.g., as described in connection with FIGS. 2 through 8 ).

In a tenth aspect, alone or in combination with one or more of the first through ninth aspects, process 1000 includes receiving, from the UE, capability information that indicates a number of TAGs supported for conditional Layer 1/Layer 2 triggered mobility (C-LTM) (e.g., as described in connection with FIGS. 2 through 8 ).

In an eleventh aspect, alone or in combination with one or more of the first through tenth aspects, process 1000 includes receiving, from the UE, capability information that indicates a first number of TAGs supported for serving cells and a second number of TAGs supported for candidate cells (e.g., as described in connection with FIGS. 2 through 8 ).

In a twelfth aspect, alone or in combination with one or more of the first through eleventh aspects, process 1000 includes receiving, from the UE, capability information that indicates one or more groups of frequency bands supported for one or more TAGs associated with candidate cells (e.g., as described in connection with FIGS. 2 through 8 ).

In a thirteenth aspect, alone or in combination with one or more of the first through twelfth aspects, process 1000 includes receiving, from the UE, capability information that indicates support for one or more TAGs associated with candidate cells, where the support is indicated for one or more of one or more frequency band combinations, one or more feature sets, one or more frequency bands, one or more radio access technologies, one or more wireless system types, or one or more NTN types (e.g., as described in connection with FIGS. 2 through 8 ).

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 2 through 8. Additionally, or alternatively, the apparatus 1100 may be configured to perform one or more processes described herein, such as process 900 of FIG. 9. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive, from a serving cell belonging to a first TAG, a control message that configures a candidate cell, information identifying a second TAG to which the candidate cell belongs, and mapping information that identifies a mapping between the first TAG and the second TAG. The communication manager 1106 may perform a handover between the serving cell and the candidate cell based at least in part on the mapping information.

The reception component 1102 may receive, from the serving cell, a TA command that updates the TA value based at least in part on indicating a first TAG ID that points to the first TAG or a second TAG ID that points to the second TAG.

The reception component 1102 may receive, from the serving cell, a TA command that updates the first TA value, wherein the second TA value is updated based at least in part on the updated first TA value based at least in part on the mapping information.

The communication manager 1106 may determine a state of the second TA timer based at least in part on the first TA timer in accordance with the mapping information.

The transmission component 1104 may transmit, to the serving cell, an RRC complete message that indicates preferred mapping information based at least in part on the mapping information.

The communication manager 1106 may determine that the serving cell is invalid for wireless communications, wherein a TA value for the candidate cell is invalid based at least in part on the serving cell being invalid and the mapping information.

The transmission component 1104 may transmit, to the serving cell, capability information that indicates a number of TAGs supported for candidate cells.

The transmission component 1104 may transmit, to the serving cell, capability information that indicates a first number of TAGs supported for serving cells and a second number of TAGs supported for candidate cells.

The transmission component 1104 may transmit, to the serving cell, capability information that indicates one or more groups of frequency bands supported for one or more TAGs associated with candidate cells.

The transmission component 1104 may transmit, to the serving cell, capability information that indicates support for one or more TAGs associated with candidate cells, wherein the support is indicated for one or more of one or more frequency band combinations, one or more feature sets, one or more frequency bands, one or more radio access technologies, one or more wireless system types, or one or more NTN types.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 2 through 8. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 or the transmission component 1204 may include or may be included in a network interface. The network interface may be configured to obtain or output signals for the apparatus 1200 via one or more communications links, such as a backhaul link, a midhaul link, or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The transmission component 1204 may transmit, to a UE via a serving cell of the network node belonging to a first TAG, a control message that configures a candidate cell, information identifying a second TAG to which the candidate cell belongs, and mapping information that identifies a mapping between the first TAG and the second TAG.

The transmission component 1204 may transmit, to the UE, a TA command that updates the TA value based at least in part on indicating a first TAG ID that points to the first TAG or a second TAG ID that points to the second TAG.

The transmission component 1204 may transmit, to the UE, a TA command that updates the first TA value, wherein the second TA value is updated based at least in part on to the updated first TA value based at least in part on the mapping information.

The reception component 1202 may receive, from the UE, an RRC complete message that indicates preferred mapping information based at least in part on the mapping information.

The reception component 1202 may receive, from the UE, capability information that indicates a number of TAGs supported for conditional Layer 1/Layer 2 triggered mobility (C-LTM).

The reception component 1202 may receive, from the UE, capability information that indicates a first number of TAGs supported for serving cells and a second number of TAGs supported for candidate cells.

The reception component 1202 may receive, from the UE, capability information that indicates one or more groups of frequency bands supported for one or more TAGs associated with candidate cells.

The reception component 1202 may receive, from the UE, capability information that indicates support for one or more TAGs associated with candidate cells, wherein the support is indicated for one or more of one or more frequency band combinations, one or more feature sets, one or more frequency bands, one or more radio access technologies, one or more wireless system types, or one or more NTN types.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a serving cell belonging to a first timing advance group (TAG), a control message that configures a candidate cell, information identifying a second TAG to which the candidate cell belongs, and mapping information that identifies a mapping between the first TAG and the second TAG; and performing a handover between the serving cell and the candidate cell based at least in part on the mapping information.

Aspect 2: The method of Aspect 1, the handover is a random access channel (RACH)-less handover that skips an uplink synchronization procedure based at least in part on the mapping information indicating that a time alignment (TA) value of the second TAG is valid at a time that the handover is triggered.

Aspect 3: The method of any of Aspects 1-2, wherein the mapping information identifies the mapping between the first TAG and the second TAG based at least in part on indicating a first identifier (ID) that points to the serving cell and a second ID that points to the candidate cell.

Aspect 4: The method of any of Aspects 1-3, wherein the serving cell is associated with a smallest or largest TAG identifier (ID) of a set of TAG IDs, and wherein the mapping information identifies that the second TAG mapped to the first TAG based at least in part on indicating that an ID that points to the candidate cell is mapped to the smallest or largest TAG ID.

Aspect 5: The method of any of Aspects 1-4, wherein the control message configures and enables the mapping information.

Aspect 6: The method of any of Aspects 1-5, wherein the control message configures the mapping information, the method further comprising: receiving, from the serving cell after receiving the control message, control information that enables the mapping information.

Aspect 7: The method of any of Aspects 1-6, wherein the mapping information indicates that the second TAG shares a time alignment (TA) timer and a TA value with the first TAG.

Aspect 8: The method of Aspect 7, further comprising: receiving, from the serving cell, a TA command that updates the TA value based at least in part on indicating a first TAG identifier (ID) that points to the first TAG or a second TAG ID that points to the second TAG.

Aspect 9: The method of any of Aspects 1-8, wherein the first TAG has a first time alignment (TA) timer and a first TA value and the second TAG has a second TA timer and a second TA value, and wherein the mapping information indicates that updates to the first TA timer and the first TA value apply to the second TA timer and the second TA value.

Aspect 10: The method of Aspect 9, further comprising: receiving, from the serving cell, a TA command that updates the first TA value, wherein the second TA value is updated based at least in part on the updated first TA value based at least in part on the mapping information.

Aspect 11: The method of Aspect 9, further comprising: determining a state of the second TA timer based at least in part on the first TA timer in accordance with the mapping information.

Aspect 12: The method of any of Aspects 1-11, further comprising: transmitting, to the serving cell, a radio resource control (RRC) complete message that

indicates preferred mapping information based at least in part on the mapping information.

Aspect 13: The method of any of Aspects 1-12, further comprising: determining that the serving cell is invalid for wireless communications, wherein a time alignment (TA) value for the candidate cell is invalid based at least in part on the serving cell being invalid and the mapping information.

Aspect 14: The method of any of Aspects 1-13, further comprising: transmitting, to the serving cell, capability information that indicates a number of TAGs supported for candidate cells.

Aspect 15: The method of any of Aspects 1-14, further comprising: transmitting, to the serving cell, capability information that indicates a first number of TAGs supported for serving cells and a second number of TAGs supported for candidate cells.

Aspect 16: The method of any of Aspects 1-15, further comprising: transmitting, to the serving cell, capability information that indicates one or more groups of frequency bands supported for one or more TAGs associated with candidate cells.

Aspect 17: The method of any of Aspects 1-16, further comprising: transmitting, to the serving cell, capability information that indicates support for one or more TAGs associated with candidate cells, wherein the support is indicated for one or more of one or more frequency band combinations, one or more feature sets, one or more frequency bands, one or more radio access technologies, one or more wireless system types, or one or more non-terrestrial network (NTN) types.

Aspect 18: A method of wireless communication performed by a network node, comprising: transmitting, to a user equipment (UE) via a serving cell of the network node belonging to a first timing advance group (TAG), a control message that configures a candidate cell, information identifying a second TAG to which the candidate cell belongs, and mapping information that identifies a mapping between the first TAG and the second TAG.

Aspect 19: The method of Aspect 18, wherein the mapping information identifies the mapping between the first TAG and the second TAG based at least in part on indicating a first identifier (ID) that points to the serving cell and a second ID that points to the candidate cell.

Aspect 20: The method of any of Aspects 18-19, wherein the serving cell is associated with a smallest or largest TAG identifier (ID) of a set of TAG IDs, and wherein the mapping information identifies that the second TAG mapped to the first TAG based at least in part on indicating that an ID that points to the candidate cell is mapped to the smallest or largest TAG ID.

Aspect 21: The method of any of Aspects 18-20, wherein the control message configures and enables the mapping information.

Aspect 22: The method of any of Aspects 18-21, wherein the control message configures the mapping information, the method further comprising: transmitting, to the UE after transmitting the control message, control information that enables the mapping information.

Aspect 23: The method of any of Aspects 18-22, wherein the mapping information indicates that the second TAG shares a time alignment (TA) timer and a TA value with the first TAG.

Aspect 24: The method of Aspect 23, further comprising: transmitting, to the UE, a TA command that updates the TA value based at least in part on indicating a first TAG identifier (ID) that points to the first TAG or a second TAG ID that points to the second TAG.

Aspect 25: The method of any of Aspects 18-24, wherein the first TAG has a first time alignment (TA) timer and a first TA value and the second TAG has a second TA timer and a second TA value, and wherein the mapping information indicates that updates to the first TA timer and the first TA value apply to the second TA timer and the second TA value.

Aspect 26: The method of Aspect 25, further comprising: transmitting, to the UE, a TA command that updates the first TA value, wherein the second TA value is updated based at least in part on to the updated first TA value based at least in part on the mapping information.

Aspect 27: The method of any of Aspects 18-26, further comprising: receiving, from the UE, a radio resource control (RRC) complete message that indicates preferred mapping information based at least in part on the mapping information.

Aspect 28: The method of any of Aspects 18-27, further comprising: receiving, from the UE, capability information that indicates a number of TAGs supported for conditional Layer 1/Layer 2 triggered mobility (C-LTM).

Aspect 29: The method of any of Aspects 18-28, further comprising: receiving, from the UE, capability information that indicates a first number of TAGs supported for serving cells and a second number of TAGs supported for candidate cells.

Aspect 30: The method of any of Aspects 18-29, further comprising: receiving, from the UE, capability information that indicates one or more groups of frequency bands supported for one or more TAGs associated with candidate cells.

Aspect 31: The method of any of Aspects 18-30, further comprising: receiving, from the UE, capability information that indicates support for one or more TAGs associated with candidate cells, wherein the support is indicated for one or more of one or more frequency band combinations, one or more feature sets, one or more frequency bands, one or more radio access technologies, one or more wireless system types, or one or more non-terrestrial network (NTN) types.

Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-31.

Aspect 33: An apparatus for wireless communication at a device, the apparatus comprising one or more memories and one or more processors coupled to the one or more memories, the one or more processors configured to cause the device to perform the method of one or more of Aspects 1-31.

Aspect 34: An apparatus for wireless communication, the apparatus comprising at least one means for performing the method of one or more of Aspects 1-31.

Aspect 35: A non-transitory computer-readable medium storing code for wireless communication, the code comprising instructions executable by one or more processors to perform the method of one or more of Aspects 1-31.

Aspect 36: A non-transitory computer-readable medium storing a set of instructions for wireless communication, the set of instructions comprising one or more instructions that, when executed by one or more processors of a device, cause the device to perform the method of one or more of Aspects 1-31.

Aspect 37: A device for wireless communication, the device comprising a processing system that includes one or more processors and one or more memories coupled with the one or more processors, the processing system configured to cause the device to perform the method of one or more of Aspects 1-31.

Aspect 38: An apparatus for wireless communication at a device, the apparatus comprising one or more memories and one or more processors coupled to the one or more memories, the one or more processors individually or collectively configured to cause the device to perform the method of one or more of Aspects 1-31.

Aspect 39: A device comprising a processing system that includes one or more processors and one or more code-storing memories coupled with the one or more processors, the processing system configured to cause the device to perform the method of one or more of Aspects 1-31.

Aspect 40: A device comprising a processing system that includes processor circuitry and code-storing memory circuitry, the processing system configured to cause the device to perform the method of one or more of Aspects 1-31.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled to the one or more memories, the one or more processors individually or collectively configured to:
receive, from a serving cell belonging to a first timing advance group (TAG), a control message that configures a candidate cell, information identifying a second TAG to which the candidate cell belongs, and mapping information that identifies a mapping between the first TAG and the second TAG; and
transmit, to the candidate cell, a random access message as part of a handover between the serving cell and the candidate cell using the mapping information.

2. The UE of claim 1, wherein the handover is a random access channel (RACH)-less handover that skips an uplink synchronization procedure using the mapping information indicating that a time alignment (TA) value of the second TAG is valid at a time that the handover is triggered.

3. The UE of claim 1, wherein the mapping information identifies the mapping between the first TAG and the second TAG, wherein the mapping information indicates a first identifier (ID) that points to the serving cell and a second ID that points to the candidate cell.

4. The UE of claim 1, wherein the serving cell is mapped to a smallest or largest TAG identifier (ID) of a set of TAG IDs, wherein the mapping information identifies that the second TAG mapped to the first TAG, and wherein the mapping information indicates that an ID that points to the candidate cell is mapped to the smallest or largest TAG ID.

5. The UE of claim 1, wherein the control message configures and enables the mapping information.

6. The UE of claim 1, wherein the control message configures the mapping information, and wherein the one or more processors are individually or collectively further configured to:
receive, from the serving cell after receiving the control message, control information that enables the mapping information.

7. The UE of claim 1, wherein the mapping information indicates that the second TAG shares a time alignment (TA) timer and a TA value with the first TAG.

8. The UE of claim 7, wherein the one or more processors are individually or collectively further configured to:
receive, from the serving cell, a TA command that updates the TA value based at least in part on indicating a first TAG identifier (ID) that points to the first TAG or a second TAG ID that points to the second TAG.

9. The UE of claim 1, wherein the first TAG has a first time alignment (TA) timer and a first TA value and the second TAG has a second TA timer and a second TA value, and wherein the mapping information indicates that updates to the first TA timer and the first TA value apply to the second TA timer and the second TA value.

10. The UE of claim 9, wherein the one or more processors are individually or collectively further configured to:
receive, from the serving cell, a TA command that updates the first TA value, wherein the second TA value is updated based at least in part on the updated first TA value using the mapping information.

11. The UE of claim 9, wherein the one or more processors are individually or collectively further configured to:
determine a state of the second TA timer using the first TA timer in accordance with the mapping information.

12. The UE of claim 1, wherein the one or more processors are individually or collectively further configured to:
transmit, to the serving cell, a radio resource control (RRC) complete message that indicates preferred mapping information using the mapping information.

13. The UE of claim 1, wherein the one or more processors are individually or collectively further configured to:
determine that the serving cell is invalid for wireless communications, wherein a time alignment (TA) value for the candidate cell is invalid in accordance with the serving cell being invalid and the mapping information.

14. The UE of claim 1, wherein the one or more processors are individually or collectively further configured to:
transmit, to the serving cell, capability information that indicates a number of TAGs supported for candidate cells.

15. The UE of claim 1, wherein the one or more processors are individually or collectively further configured to:
transmit, to the serving cell, capability information that indicates a first number of TAGs supported for serving cells and a second number of TAGs supported for candidate cells.

16. The UE of claim 1, wherein the one or more processors are individually or collectively further configured to:
transmit, to the serving cell, capability information that indicates one or more groups of frequency bands supported for one or more TAGs mapped to candidate cells.

17. The UE of claim 1, wherein the one or more processors are individually or collectively further configured to:
transmit, to the serving cell, capability information that indicates support for one or more TAGs associated with candidate cells, wherein the support is indicated for one or more of one or more frequency band combinations, one or more feature sets, one or more frequency bands, one or more radio access technologies, one or more wireless system types, or one or more non-terrestrial network (NTN) types.

18. A method of wireless communication performed by a user equipment (UE), comprising:
receiving, from a serving cell belonging to a first timing advance group (TAG), a control message that configures a candidate cell, information identifying a second TAG to which the candidate cell belongs, and mapping information that identifies a mapping between the first TAG and the second TAG; and
transmitting, to the candidate cell, a random access message as part of a handover between the serving cell and the candidate cell using the mapping information.

19. The method of claim 18, wherein the handover is a random access channel (RACH)-less handover that skips an uplink synchronization procedure using the mapping information indicating that a time alignment (TA) value of the second TAG is valid at a time that the handover is triggered.

20. An apparatus for wireless communication, comprising:
means for receiving, from a serving cell belonging to a first timing advance group (TAG), a control message that configures a candidate cell, information identifying a second TAG to which the candidate cell belongs, and mapping information that identifies a mapping between the first TAG and the second TAG; and
means transmitting, to the candidate cell, a random access message as part of a handover between the serving cell and the candidate cell using the mapping information.
